(19) United States
(12) Patent Application Publication
(10) Pub. No.: US 2026/0289193 A1
(43) Pub. Date: Sep. 24, 2026

(54) SYSTEM

(71) Applicant: SoftBank Group Corp., Tokyo (JP)

(72) Inventor: Shinji HORI, Tokyo (JP)

(73) Assignee: SoftBank Group Corp., Tokyo (JP)

(21) Appl. No.: 19/550,267

(22) Filed: Feb. 26, 2026

Related U.S. Application Data
(60) Provisional application No. 63/773,594, filed on Mar. 18, 2025.

(51) Int. Cl. G06F 40/58; G06F 40/166; G06F 40/242; G06F 40/30; G06F 40/51; G10L 13/027; G10L 15/00; G10L 15/04; G10L 15/183

(52) U.S. Cl. CPC G06F 40/58; G06F 40/166; G06F 40/242; G06F 40/30; G06F 40/51; G10L 13/027; G10L 15/005; G10L 15/04; G10L 15/183

(57) ABSTRACT

A system includes a processor that is configured to capture, in real time, speech of each participant in a meeting and convert corresponding audio data into text data, wherein the processor is configured to translate, in real time, the text data into a language understandable by participants, and wherein the processor is configured to convert the translated text into audio and output the audio to other participants.

### CROSS-REFERENCE TO RELATED APPLICATION

This application claims the benefit of U.S. Provisional Application No. 63/773,594, filed on Mar. 18, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional meeting systems that support remote or hybrid conferences generally provide basic audio or video communication and may record audio or text logs. However, such systems often fail to offer seamless real-time communication among participants who speak different languages. Participants must either rely on human interpreters or manually operate separate translation tools, which introduces delays, misunderstanding of technical or business-specific terms, and increased cognitive load.

Furthermore, conventional systems typically require manual note-taking and manual creation of meeting minutes. As a result, important details, decisions, and action items may be omitted or inaccurately captured. This manual process also makes it difficult to search past discussions efficiently and to share consistent records among all participants.

In addition, conventional systems do not sufficiently automate post-meeting follow-up activities. Tasks and action items decided during the meeting are often tracked in separate tools or spreadsheets, requiring manual extraction and entry by participants or facilitators. This fragmentation causes missed deadlines, unclear responsibilities, and inefficient coordination.

Moreover, scheduling subsequent meetings in a multi-participant, multi-time-zone environment is typically handled by manual email exchanges or separate scheduling tools. This manual process is time-consuming and prone to conflicts, especially when participants have different calendar systems or overlapping constraints.

Therefore, there is a need for a system that can, in an integrated manner, perform real-time speech recognition, translation, and audio synthesis for multilingual meetings, automatically create and store organized meeting minutes, automatically extract and manage tasks and action items, and support automated scheduling of the next meeting based on participant availability. The present invention has been made in view of these problems.

### SUMMARY

In order to solve at least part of the above-described problems, an aspect of the present invention provides a system comprising a processor, wherein the processor is configured to capture, in real time, speech of each participant in a meeting and convert corresponding audio data into text data. By performing real-time speech recognition for each participant, the system generates a text representation of the meeting utterances that can be further processed and shared.

The processor is further configured to translate, in real time, the text data into a language understandable by participants. The processor may use one or more language models or neural translation engines to convert recognized text from a source language into one or more target languages corresponding to participants' preferences. By doing so, the system enables multilingual participants to understand each other's utterances immediately, without requiring separate translation tools or human interpreters.

The processor is also configured to convert the translated text into audio and output the audio to other participants. By synthesizing speech corresponding to the translated text and providing audio output to terminals of the participants, the system allows each participant to listen to other participants' speech in a preferred language, thereby improving naturalness and accessibility of communication during the meeting.

In another aspect, the processor is configured to automatically record the text data obtained by the speech recognition, organize the text data in accordance with progress of the meeting, and store the organized text data in cloud storage. Through this automatic minutes creation function, the system generates a time-ordered, structured record of the meeting content, which can be accurately understood and referred to later by all participants. The stored minutes can be searched or shared, which improves traceability and reduces the need for manual note-taking.

In a further aspect, the processor is configured to provide a ToDo management function and a next meeting setup function. By the ToDo management function, the processor is configured to automatically extract tasks and action items decided during the meeting, generate a list of the tasks and action items, and share the list with participants so that follow-up after the meeting can be performed smoothly. The processor may analyze the recognized text data, detect phrases corresponding to commitments, assignments, and deadlines, and create structured ToDo entries associated with responsible participants and due dates.

By the next meeting setup function, the processor is configured to propose an optimal date and time for a next meeting by taking schedules of the participants into consideration and to automatically adjust schedules of the participants by linking with a calendar application. The processor may obtain availability information from calendar systems associated with the participants, compute candidate time slots that satisfy specified constraints, and present the candidates to the participants for confirmation. Upon confirmation, the processor may create or update calendar events automatically.

According to these aspects, the system integrates real-time multilingual communication, automatic minutes generation, automatic task extraction and sharing, and automated scheduling of subsequent meetings. As a result, the system can reduce language barriers, minimize manual effort for documentation and follow-up, and improve efficiency and reliability of collaborative meetings.

The term “system” refers to an arrangement of one or more hardware and software components that collectively perform the functions recited in the claims, including speech recognition, translation, audio synthesis, minutes generation, ToDo management, and meeting setup.

The term “processor” refers to any hardware logic device or combination of devices, such as a central processing unit (CPU), graphics processing unit (GPU), digital signal processor (DSP), microcontroller, or programmable logic circuitry, configured to execute instructions so as to perform the functions specified in the claims.

The term “speech of each participant in a meeting” refers to audible utterances produced by individual human participants during a meeting session, including words, phrases, and sentences intended to convey information, questions, or responses.

The term “real time” refers to processing that is performed with sufficiently low latency that participants can perceive results, such as recognition, translation, or synthesis, substantially without noticeable delay relative to the ongoing meeting conversation.

The term “audio data” refers to digitized representations of sound signals, including sampled waveforms, encoded bitstreams, or other digital formats derived from acoustic signals captured by a microphone or other audio input device.

The term “text data” refers to a digital representation of linguistic content in the form of characters, symbols, or tokens, which are derived from processing audio data and suitable for display, storage, translation, or further text-based analysis.

The term “language understandable by participants” refers to a natural language that a given participant is able to read, listen to, or comprehend, such as the participant's native language or a designated working language for the meeting.

The term “translate” refers to converting text data expressed in a source natural language into corresponding text data expressed in a target natural language, while preserving at least the essential semantic content and intended meaning.

The term “translated text” refers to text data that has been produced by translating original text data from one natural language into another natural language.

The term “convert the translated text into audio” refers to generating synthesized speech signals from translated text data using text-to-speech or similar audio synthesis techniques so that the translated content can be audibly presented.

The term “other participants” refers to one or more meeting participants who are different from the speaker of the original utterance and who receive the translated text or synthesized audio corresponding to that utterance.

The term “speech recognition” refers to processing of audio data to detect and identify spoken words and phrases and to convert them into corresponding text data, optionally including language detection, segmentation, and post-processing.

The term “meeting minutes” refers to a record of the contents of a meeting, including at least part of the recognized text data, and optionally including time information, speaker identification, summaries, decisions, and action items.

The term “cloud storage” refers to a remote storage infrastructure accessible over a network, in which digital data such as meeting minutes, transcripts, and associated metadata are stored and managed on one or more servers or storage services.

The term “ToDo management function” refers to functionality that automatically or semi-automatically identifies, creates, stores, updates, and shares task information and action items that are decided during a meeting.

The term “task” refers to a unit of work or action to be performed, which is typically associated with a description, an assignee, and optionally a due date or priority.

The term “action item” refers to a specific type of task that arises from a meeting discussion or decision and that is assigned to one or more participants for follow-up after the meeting.

The term “list of the tasks and action items” refers to a structured collection of entries representing tasks and action items, where each entry may include at least a description and may further include fields such as assignee, due date, and status.

The term “share the list with participants” refers to making the list of tasks and action items available to meeting participants through one or more user interfaces or communication channels, such as terminal screens, emails, or notifications.

The term “follow-up after the meeting” refers to activities performed after a meeting has ended, including performing tasks, tracking progress, confirming completion, and reviewing or updating associated records.

The term “next meeting setup function” refers to functionality that proposes and optionally confirms a date and time for a subsequent meeting by considering participant schedules and by coordinating with calendar systems.

The term “optimal date and time” refers to a date and time selected based on one or more criteria, such as maximizing the number of available participants, respecting time zones, and satisfying predefined constraints or preferences.

The term “schedules of the participants” refers to information representing time availability and existing commitments of participants, typically obtained from calendar systems or user-defined availability data.

The term “calendar application” refers to a software service or program that maintains time-based events and scheduling information for users, and that provides an interface or API for creating, modifying, or querying events.

The term “automatically adjust schedules of the participants” refers to creating, updating, or canceling one or more calendar events in the participants' calendar applications, without requiring each participant to manually enter all event details.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

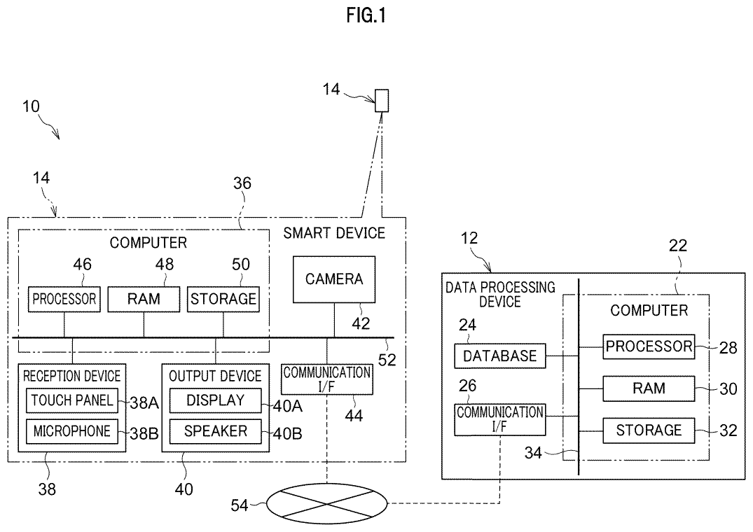

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

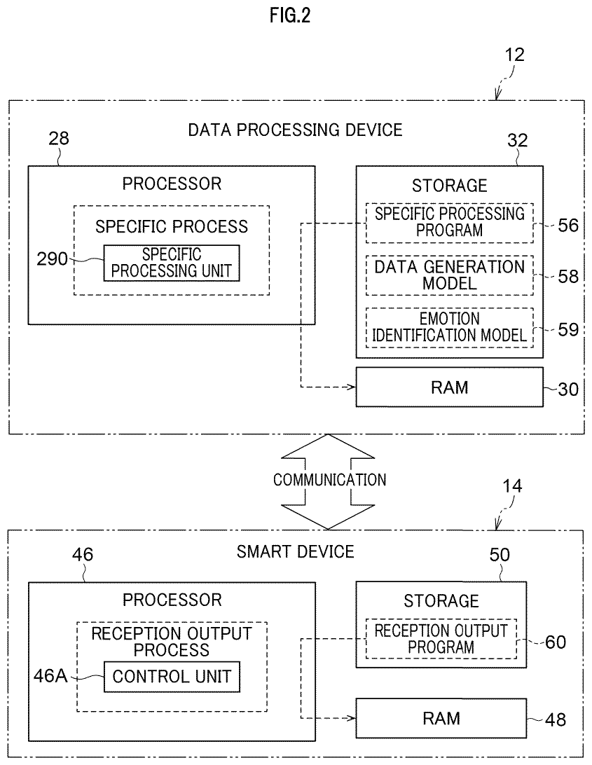

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented meeting support systems that provide speech recognition, translation, and text-to-speech capabilities typically operate as a loosely coupled sequence of independent modules. A first module converts audio to text, a second module performs rule-based or statistical machine translation, and a third module performs speech synthesis. These modules usually apply fixed models and static configurations and do not dynamically adapt to meeting context, speaker characteristics, or downstream tasks such as minutes generation, task extraction, and scheduling. As a result, such systems often suffer from degraded accuracy for domain-specific terminology, inconsistent translations across a single meeting, and failure to capture the pragmatic or cultural nuances that are important for multilingual collaboration.

Furthermore, conventional systems generally treat meeting minutes creation, task management, and scheduling as separate post-processing applications that either rely on manual user input or simplistic keyword-based extraction. These approaches impose a substantial cognitive and operational burden on users, require repeated manual review of long transcripts, and frequently result in incomplete or inconsistent records of decisions, action items, and schedules. System resources such as processors and storage devices are often used inefficiently, because the same meeting data is repeatedly processed by unrelated tools without a unified data model or optimization across tasks.

Moreover, naive integration of generative AI models into such pipelines risks producing non-deterministic or hallucinated outputs that are difficult to align with the underlying structured meeting data. Without explicit prompt control and tight coupling between generative AI outputs and machine-readable records, it is difficult to use generative AI models reliably for downstream computer processing tasks such as indexing, search, task tracking, and calendar synchronization. In addition, conventional systems typically do not exploit generative AI models to optimize low-level system behavior, such as the selection and refinement of translation outputs, generation of structured metadata, and automatic resolution of time expressions for scheduling.

Accordingly, there is a need for an improved computer-implemented meeting support system and server-side processing architecture that (i) combine deterministic, model-based processing with generative AI models under explicit prompt control, (ii) treat translation, minutes generation, task extraction, and scheduling as interconnected computational tasks operating on shared structured data, and (iii) thereby improve the functioning of the computer system itself, including improved accuracy, consistency, and machine-actionable structure of the generated outputs, more efficient use of processing and storage resources, and reduced manual intervention by users in multilingual, multi-participant meetings.

The specific processing by the specific processing unit 290 of the data processing device 12 in Example 1 is realized by the following means.

The present invention provides a server comprising a processor and a memory storing instructions that, when executed by the processor, cause the processor to cooperate with a plurality of information processing terminals to acquire audio signals from audio input devices of the terminals in a time series, perform noise reduction and speech-section extraction on the audio signals, automatically determine a language used by a speaker in each speech section, select an acoustic model and a language model corresponding to the determined language, and convert the speech section into character information based on the selected models; to aggregate, via a communication network, the character information and associated language-type information, determine, for each meeting participant, a translation target language based on display-language information stored in association with participant identifiers, execute a machine translation process in accordance with the determined translation target language to obtain preliminary translation character information, and construct and transmit to a generative AI model an input that includes the preliminary translation character information, original character information, and an explicit prompt sentence specifying a translation task, so that refined translation character information is obtained from the generative AI model and used to correct the preliminary translation character information while preserving context, technical terminology, and cultural nuances; to distribute the refined translation character information to the terminals according to the display languages of the respective participants, and to invoke, at the server or at the terminals, a generative AI model with the refined translation character information and an explicit prompt sentence specifying a speech-synthesis task in order to obtain audio-synthesis parameters or synthesized audio that are used to convert the refined translation character information into an audio signal output at an audio output device of each terminal; to store, in association with meeting identification information, speaker identification information, and time information, both the character information obtained from the audio signals and the refined translation character information as meeting record data in a storage device, to assign search index information to the meeting record data, and to submit the meeting record data together with an explicit prompt sentence specifying a minutes-generation task to a generative AI model so that structured meeting records organized by agenda, including summary information and speaker- and time-aligned metadata, are generated and stored; to identify candidate speech sections containing task expressions from the meeting record data, submit the candidate speech sections together with an explicit prompt sentence specifying an automatic task-listing task to a generative AI model, receive machine-readable work-item information including task content, responsible person, deadline, and priority, register the work-item information as task management data in the storage device, and provide interfaces for the terminals to present, update, and track the task management data; and to obtain, via schedule-management-information acquisition processing, free-time information and time-constraint information for a plurality of participants, generate a set of candidate meeting dates and times, submit the candidate meeting dates and times together with an explicit prompt sentence specifying an optimal-scheduling task to a generative AI model, receive recommended meeting date-and-time information that accounts for numbers of potential attendees and time constraints, and register schedule information corresponding to the recommended meeting date and time in schedule-management information for the participants in cooperation with a calendar management function. This enables the computer system to integrate deterministic speech and translation processing with generative AI model outputs under explicit prompt control, to automatically produce consistent and machine-actionable multilingual meeting records, tasks, and schedules, to reduce repeated manual review and data entry by users, and to improve the accuracy, structure, and efficiency of meeting-related processing performed by the server and the cooperating terminals.

The term “audio signal” refers to a time-varying electrical or digital representation of sound captured from an audio input device and processed by the system in a time series.

The term “audio input device” refers to a hardware component, such as a microphone or equivalent transducer, that converts acoustic sound waves produced by a meeting participant into an audio signal usable by an information processing terminal.

The term “audio output device” refers to a hardware component, such as a loudspeaker, headphone, or earphone, that converts an audio signal into acoustic sound perceivable by a meeting participant.

The term “information processing terminal” refers to a user-operated computing apparatus, such as a portable terminal, a stationary terminal, or another general-purpose computing device, that is configured to capture audio, communicate with a server, present information to a user, and execute at least part of the processing described herein.

The term “server” refers to a computing apparatus or a group of cooperating computing apparatuses, each including at least one processor and a memory, that is configured to provide centralized processing, storage, and coordination functions for a plurality of information processing terminals.

The term “processor” refers to a hardware execution unit, such as a central processing unit, a graphics processing unit, or a dedicated accelerator, that executes instructions to perform the functions described in connection with the system.

The term “memory” refers to any non-transitory computer-readable storage medium that stores instructions and data for execution by the processor, including but not limited to semiconductor memory, magnetic storage, and optical storage.

The term “noise reduction” refers to a signal processing operation that reduces or suppresses unwanted components of an audio signal, such as background noise, echo, or reverberation, while preserving speech components.

The term “speech section” refers to a time interval within an audio signal that is determined to contain spoken content produced by a meeting participant, as opposed to silence or non-speech noise.

The term “language determination” refers to a computational process that analyzes an audio signal or character information to identify a natural language used by a speaker, such as English, Japanese, or another human language.

The term “acoustic model” refers to a statistical or neural model that represents a relationship between acoustic features of an audio signal and basic linguistic units, such as phonemes or subword units, for a particular language.

The term “language model” refers to a statistical or neural model that represents probabilities of sequences of linguistic units, such as words or subword units, in a particular language, and is used to improve recognition and generation accuracy.

The term “character information” refers to digital text data representing linguistic content, including letters, symbols, or characters corresponding to spoken utterances or translated text.

The term “language-type information” refers to metadata indicating a type of natural language associated with particular character information or an audio segment, such as a language code or classification label.

The term “display-language information” refers to configuration data associated with a meeting participant that specifies a preferred natural language for presenting character information or synthesized speech.

The term “translation target language” refers to a natural language into which character information is to be translated based on display-language information for a meeting participant.

The term “machine translation process” refers to an automated computational procedure that converts character information expressed in a source language into character information expressed in a target language using algorithmic models.

The term “preliminary translation character information” refers to character information generated as an initial translation result by the machine translation process before refinement using a generative AI model.

The term “refined translation character information” refers to translation character information that has been corrected or improved using output from a generative AI model, taking into account context, technical terminology, and cultural nuances.

The term “prompt sentence” refers to an explicit textual instruction or set of instructions provided as part of input to a generative AI model to specify a task to be performed by the generative AI model.

The term “generative AI model” refers to a machine-learned model that, in response to input including data and a prompt sentence, generates output such as text, parameters, or audio in a manner that is not limited to selecting from a fixed set of predefined outputs.

The term “audio-synthesis parameters” refers to numerical or symbolic parameters, such as prosody parameters, voice characteristics, or timing information, that control a process of converting character information into an audio signal.

The term “synthesized audio” refers to an audio signal generated by a computational process based on character information and optionally audio-synthesis parameters, rather than captured directly from a human speaker.

The term “meeting identification information” refers to data that uniquely identifies a particular meeting instance within the system, such as an identifier or a combination of identifiers.

The term “speaker identification information” refers to data that identifies a participant who produced a particular utterance, such as a user identifier or a device identifier.

The term “time information” refers to data representing a temporal attribute of an utterance or event, such as a timestamp or a time interval.

The term “meeting record data” refers to structured data that includes at least character information derived from audio signals, refined translation character information, and associated metadata such as meeting identification information, speaker identification information, and time information.

The term “search index information” refers to data structures, such as index entries or keys, that enable efficient retrieval of meeting record data in response to search queries.

The term “storage device” refers to a hardware component or subsystem that stores data persistently, including local storage in the server or network-connected storage.

The term “meeting record” refers to a human-readable representation of meeting record data, organized and formatted for comprehension, and including at least summaries, topics, and speaker- or time-aligned content.

The term “agenda” refers to a topic, subject, or logical section of a meeting, used for organizing meeting records and minutes.

The term “candidate speech section” refers to a speech section selected as likely to contain a task expression or other specified type of content for further processing.

The term “task expression” refers to a portion of character information that indicates an action to be performed, such as a request, obligation, or assignment.

The term “work-item information” refers to structured data describing a unit of work, including at least task content, a responsible person, a deadline, and optionally a priority.

The term “task management data” refers to stored work-item information and associated metadata used to track creation, status, and changes of tasks.

The term “free-time information” refers to data representing time intervals during which a participant is available for scheduling a meeting, derived from schedule-management information.

The term “time-constraint information” refers to data representing restrictions on when a participant can attend meetings, including working hours, preferences, or existing commitments.

The term “schedule-management information” refers to data describing planned or potential time allocations for a participant, including existing events and available time slots, as maintained by a scheduling or calendar system.

The term “candidate meeting dates and times” refers to a set of proposed date-and-time combinations that are computed based on free-time information and time-constraint information as potential options for a meeting.

The term “recommended meeting date and time” refers to a selected date-and-time combination for a meeting that is determined, at least in part, based on output from a generative AI model and on constraints such as participant availability.

The term “calendar management function” refers to processing that creates, updates, or deletes calendar events or schedule entries in association with schedule-management information for participants.

The term “minutes data” refers to structured data representing an organized summary of a meeting, including at least main discussion points, decisions, unresolved issues, and associated speaker and time information.

The term “structured minutes data” refers to minutes data that is organized according to a predetermined schema or format, such as sections, items, or fields, to facilitate storage, retrieval, and processing by a computer system.

In one embodiment, a server cooperates with a plurality of terminals operated by users to implement the claimed system. The server comprises at least one processor and at least one memory storing program instructions. The terminals each comprise at least one processor, at least one memory, at least one audio input device such as a microphone, at least one audio output device such as a speaker or headset, and a communication interface such as a wireless network interface.

The server executes a server-side program implemented, for example, using a web application framework on a general-purpose operating system. The terminal executes a client-side program implemented, for example, as a native application or a browser-based application on a mobile operating system or a desktop operating system. The server program and the terminal program cooperate via a communication protocol, such as a secure HTTP-based protocol or a WebSocket-based protocol.

The terminal uses an operating system audio API, such as an audio capture interface of a mobile operating system, to obtain a digital audio signal from the microphone. The terminal converts an analog voice signal from a user into pulse code modulated data at a predetermined sampling frequency, such as 16 kHz, and a predetermined bit depth, such as 16 bits. The terminal stores the digital audio samples in a circular buffer structure in memory, and segments the buffer into fixed-length frames. The terminal applies noise reduction processing, such as spectral subtraction or a recurrent-neural-network-based noise suppressor, to the individual frames. The terminal further applies voice activity detection based on energy thresholds and spectral features to identify frames corresponding to speech sections.

The terminal applies a speech recognition engine to the noise-reduced speech sections. The terminal uses, for example, a neural network acoustic model implemented as a deep neural network such as a convolutional-recurrent network or a transformer-based network. The acoustic model takes as input feature vectors computed from the audio frames, such as Mel-frequency cepstral coefficients, log Mel filterbank energies, or learned spectral embeddings. The acoustic model outputs, for each time step, a probability distribution over phonetic units or subword units.

The terminal combines the acoustic model with a language model, such as an n-gram model or a transformer-based sequence model, and executes a decoding algorithm, such as beam search with pruning thresholds, to derive a most probable character sequence.

The terminal applies a language identification model either on an initial portion of the audio or on the recognized text. The terminal uses, for example, a classifier model trained on character n-gram statistics or a small neural network model that takes as input a fixed-length sequence representation and outputs a distribution over language categories. The terminal determines a language code, such as a two-letter code or a four-letter regional code, and selects an acoustic model and language model pair corresponding to the determined language. The terminal thereby adapts the speech recognition accuracy to the language of the speaker.

The server receives recognized character information and associated metadata from each terminal. The server stores the character information in a structured data record in memory and in a persistent storage device. The server associates for each utterance a meeting identifier, a speaker identifier, a language-type indicator, and time information. The server uses a relational or document-oriented database to store the utterance records and creates indices over the time information, speaker identifier, and text fields to support efficient retrieval.

The server determines for each user a translation target language based on a user profile stored in the database. The server applies a deterministic machine translation component, such as a sequence-to-sequence neural model trained with an encoder-decoder architecture, to convert the source-language character information into preliminary translation character information in the target language. The server uses, for example, a transformer-based encoder-decoder network with multi-head attention and position-wise feedforward layers. The encoder receives tokenized source text and generates context representations, and the decoder generates target tokens conditioned on the encoder outputs and previously generated tokens.

The server then refines the preliminary translation character information using a generative AI model controlled via a prompt sentence. The server constructs a prompt sentence that explicitly specifies a translation refinement task. The server uses, for example, a prompt sentence of the form:

“Translate the following meeting utterance in real time so that participants can immediately understand it, preserving business terminology and cultural nuances. Source language: Japanese. Target language: English. Utterance: ‘Let's have the next progress report meeting next Wednesday (in Japanese).’”

The server concatenates the prompt sentence with the original character information and the preliminary translation character information into a single input sequence. The server sends the input sequence to a large-scale generative AI model, such as a transformer-based language model trained on multilingual corpora with supervised fine-tuning and reinforcement learning from human feedback. The generative AI model uses a multi-layer self-attention architecture, in which each layer computes attention weights over the entire input sequence, aggregates context vectors, and applies feedforward transformations. The generative AI model outputs a refined translation that is consistent with context and specialized terms.

The server compares the refined translation with the preliminary translation and may apply a rule-based consistency check, such as enforcing a translation dictionary for specific technical terms, or ensuring that named entities maintain consistent translations across utterances. The server then stores the refined translation character information as part of the meeting record data.

The server distributes the refined translation character information to the terminals. The terminal displays the translation as text and, if configured, performs speech synthesis. The terminal uses a text-to-speech engine that may be a local neural vocoder model or a system-provided synthesis function. The terminal may use a generative AI model to optimize prosody parameters. The terminal constructs a prompt sentence for this purpose, as in:

“Convert the following translated meeting text into natural-sounding speech and adjust intonation and rhythm so that questions and emotional emphasis are clearly expressed.”

The terminal or server sends the prompt sentence and the translation text to a generative AI model that outputs prosody control tokens or suggested phoneme-level duration and pitch contours. The terminal applies these outputs to an acoustic model and vocoder, such as a sequence-to-sequence text-to-spectrogram model followed by a neural vocoder, to synthesize an audio signal. The terminal outputs the synthesized audio via the speaker. This combination of explicit prosody control via a generative AI model and deterministic synthesis modules improves naturalness and intelligibility while still allowing the system to maintain alignment between text and audio for indexing and playback control.

The server aggregates, in the storage device, the original recognized character information and the refined translation character information together with meeting identifiers, speaker identifiers, and time information into meeting record data. The server assigns search index information by, for example, constructing inverted indices that map tokens or phrases to utterance identifiers. The server can thus answer search queries quickly by retrieving matching utterances using the indices instead of scanning entire transcripts.

The server generates structured meeting records by sending the meeting record data to a generative AI model with a minutes-generation prompt sentence. For example, the server uses: “Record all utterances during the meeting and organize them into structured, easy-to-search minutes. Summarize main discussion points, decisions, and open issues. Preserve important technical terms and include speaker names and timestamps where relevant.”

The server receives from the generative AI model a structured document that contains sections such as “Agenda,” “Discussion,” “Decisions,” and “Action Items.” The server parses the structured output according to predefined markers or headings indicated in the prompt, and stores the resulting minutes data in a machine-readable format such as a structured text representation.

The server links each summarized item with underlying utterance identifiers and time information. This linkage allows a terminal to navigate from an item in the minutes to the corresponding segments in the audio or text transcript. By structuring the minutes in this manner, the system improves data management, as the same underlying utterance records can support human-readable minutes, precise search, and analytics.

The server further extracts tasks from the meeting record data. The server identifies candidate speech sections by applying pattern matching for phrases that typically indicate tasks, such as modal verbs and obligation expressions, and by using metadata such as action item tags if present. The server then uses a generative AI model to normalize and structure the tasks. The server constructs a prompt sentence such as:

“From the following meeting transcript, automatically extract all tasks and action items. For each item, output the task description, responsible person, due date if mentioned, and priority level. Ignore generic statements that do not imply concrete actions.”

The server provides the candidate speech sections and the prompt sentence to the generative AI model. The generative AI model, implemented as a transformer network fine-tuned for information extraction, parses the input into a structured form. The server receives work-item information in a structured text format and converts it into internal task management data records. The server resolves references to participant names into internal user identifiers. The server interprets relative dates using date parsing logic that takes into account the meeting date and time zone, to convert phrases such as “next Wednesday” into absolute timestamps.

The server stores the task management data in the storage device and maintains status fields that can be updated by terminals. The server can compute summary statistics, such as counts of open tasks per participant, using efficient database queries. The server thus uses the generative AI model not only to propose human-readable text but also to produce structured data that feeds into deterministic database operations and status tracking.

The server also assists in scheduling a subsequent meeting. The server accesses schedule-management information for each participant from a calendar management function. The server receives free-time information and time-constraint information from external calendar systems via defined interfaces. The server aggregates time slot data from multiple participants and normalizes them to a uniform time representation. The server computes a set of candidate meeting dates and times by intersecting free-time intervals and applying constraints such as business hours and minimum duration. The server then invokes a generative AI model to rank and explain these options.

The server constructs a scheduling prompt sentence such as:

“Based on the following free/busy time slots for each participant and their time zones, propose three optimal date-and-time options for the next meeting. Maximize the number of attendees, keep the meeting within local business hours, and avoid national holidays if possible.”

The server provides a structured encoding of the time slot data along with the prompt sentence to the generative AI model. The generative AI model evaluates combinations of candidate slots and outputs recommended meeting date-and-time options with textual rationale. The server selects one or more recommended options and registers them as schedule entries in the calendar systems for the participants. The server ensures that the chosen times satisfy the constraints by performing a verification step that re-checks free-time intervals and avoids conflicts.

The use of generative AI models in these embodiments is not limited to mere substitution for human judgment. The server integrates the generative AI models into a pipeline that uses explicit prompt sentences, structured intermediate representations, and deterministic post-processing. The generative AI outputs are constrained to formats and conventions that are suitable for further machine processing, such as structured minutes segments and normalized task records. This tight integration improves computer functionality in several ways.

First, the server reduces translation errors and inconsistencies by combining a deterministic machine translation model with a generative AI refinement step that is guided by prompt sentences and terminology rules. The combination enables faster execution than a purely generative approach, because the coarse translation is produced by a specialized model and only refinement is handled by the generative AI. The server can parallelize deterministic translation for multiple utterances and then selectively refine only those segments that contain technical terminology or ambiguous phrasing, thereby improving computational efficiency and reducing latency.

Second, the server improves accuracy and reliability of meeting minutes and task extraction by aligning generative AI outputs with underlying utterance identifiers and time stamps. The server uses these identifiers and indices to verify completeness of coverage and to detect anomalies, such as missing sections or conflicting tasks. By maintaining a canonical underlying record and using generative AI only to derive structured summaries, the system reduces the risk of hallucinated content and improves the integrity of meeting records.

Third, the server reduces communication and storage overhead by using compact structured representations and indices. The server does not repeatedly transmit entire transcripts back and forth between components. Instead, the server transmits only incremental utterance updates to generative AI endpoints and stores normalized, indexed records. This design reduces network bandwidth consumption and improves response times for search and retrieval.

Fourth, the server implements non-conventional processing flows inside the computer system. For example, the server uses explicit prompt sentences to dynamically configure the behavior of the generative AI model according to the task type (translation, minutes generation, task extraction, scheduling). This prompt-based configuration allows the server to reuse a single generative AI model for multiple related tasks without loading separate models, which reduces memory usage and model management overhead. The server also uses explicit constraints and post-processing algorithms to transform free-form generative outputs into domain-specific data structures.

Fifth, the training and internal operation of the generative AI models contribute to technical improvement. In one embodiment, the translation refinement model is trained using supervised learning with pairs of machine translation outputs and human-corrected translations for meeting domain text. The training procedure uses a cross-entropy loss function over tokens of the refined translation and updates model weights using gradient-based optimization. Regularization techniques such as dropout and data augmentation using paraphrases and synthetic noise are applied to improve robustness. In another embodiment, the task extraction model is trained on annotated transcripts that mark task expressions, responsible persons, deadlines, and priorities. The model uses a multi-label sequence tagging architecture or a text-to-structure generation objective with a structured decoding constraint to ensure valid output format.

By specifying these architectures, loss functions, and training methods, the invention improves the performance of the generative AI components in the specific context of meeting processing. The models learn to capture latent features such as co-occurrence patterns of technical terms, dependency between utterances and subsequent decisions, and typical linguistic patterns of task assignments, which are difficult for rule-based systems or generic models to handle efficiently. Alternative embodiments are possible. In one alternative, the terminal performs not only speech recognition but also initial translation, and the server performs only refinement and storage. In another alternative, the server executes the speech recognition models on server-side accelerators, and the terminals function primarily as thin clients. In yet another alternative, the generative AI models are partitioned so that a lightweight version runs on the terminal for immediate feedback, and a larger version runs on the server for high-accuracy processing and archival records.

The server can also vary the data structures. In one embodiment, the server stores meeting record data in a time-series database that optimizes insertion and retrieval by time. In another embodiment, the server uses a graph database to represent relationships between utterances, decisions, and tasks. The server can adjust indexing strategies accordingly, for example, by building graph indices for relationships or by building composite indices over speaker and topic. The terminal can vary presentation modes. The terminal may display a timeline view where each utterance appears with icons indicating whether it has been translated, summarized, or associated with a task. The terminal may allow the user to request re-summarization or re-translation of a specific segment by sending a modified prompt sentence to the server. For example, the user may choose to apply a prompt sentence that emphasizes brevity, such as:

“Summarize the following discussion in one concise sentence suitable for a meeting action log.” In all of these embodiments, the server and the terminals execute specific sequences of data transformations on concrete data structures using defined algorithms and model architectures. These sequences are not limited to generic data acquisition, analysis, and display routines, but implement a coordinated set of machine-level operations that improve the way a computer system processes multilingual meeting data. Through the combination of deterministic models, generative AI models controlled by prompt sentences, and structured storage and indexing, the system achieves improved translation quality, better-structured and more searchable meeting records, more accurate and machine-actionable task extraction, and efficient scheduling support, thereby improving the functioning of the computer system itself.

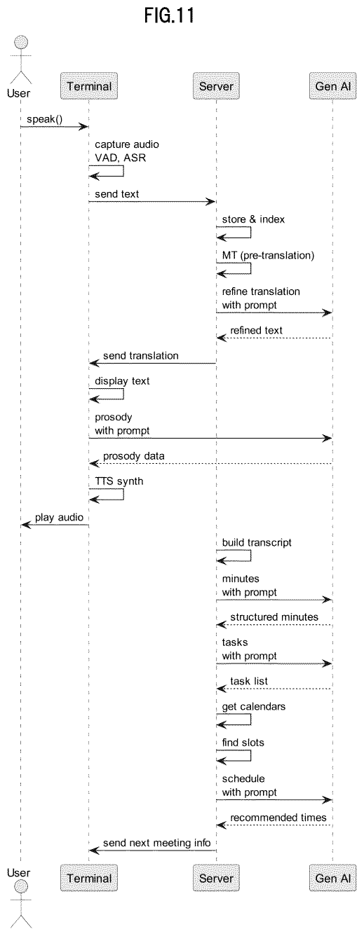

The following describes the processing flow using FIG. 11.

### Step 1:

The user speaks into a microphone of a terminal during a meeting.

The terminal receives, as input, an analog voice signal from the microphone. The terminal uses an audio capture API to sample the analog signal and to generate a stream of digital audio samples as output. The terminal stores the digital audio samples in a frame buffer and timestamps each frame.

### Step 2:

The terminal applies pre-processing to the buffered digital audio samples.

The terminal receives, as input, the digital audio frames from Step 1. The terminal performs noise reduction by applying a filter or a neural noise suppressor to attenuate background noise and echo. The terminal then executes a voice activity detection algorithm on energy and spectral features to classify each frame as speech or non-speech. The terminal outputs a sequence of speech frames grouped into speech sections with associated timestamps.

### Step 3:

The terminal performs language identification for each speech section.

The terminal receives, as input, acoustic features or a short initial portion of text decoded with a generic model from the speech sections of Step 2. The terminal computes language features, such as character n-gram statistics or averaged spectral embeddings, and applies a trained classifier to estimate probabilities for candidate languages. The terminal selects the language with the highest probability and outputs a language code associated with each speech section.

### Step 4:

The terminal executes speech recognition using language-specific models.

The terminal receives, as input, the speech sections and corresponding language codes from Steps 2 and 3. The terminal selects an acoustic model and a language model based on each language code. The terminal computes feature vectors, such as log Mel filterbank energies, for each frame and feeds the feature sequence into a neural acoustic model to obtain probability distributions over phonetic units. The terminal combines these probabilities with the language model in a beam search decoder to generate a most probable text sequence. The terminal outputs recognized character information with metadata including speaker identifier, language code, start time, and end time.

### Step 5:

The terminal transmits recognized text and metadata to the server.

The terminal receives, as input, the recognized character information and metadata from Step 4.

The terminal packages the data into a structured message including fields for meeting identifier, speaker identifier, language code, timestamps, and text. The terminal opens or reuses a secure network connection and performs an HTTP or WebSocket send operation. The terminal outputs the structured message to the server as a network packet.

### Step 6:

The server stores and indexes incoming utterance data.

The server receives, as input, the structured message from Step 5. The server parses the message, validates required fields, and converts timestamps to a unified format. The server writes the character information and metadata into a meeting record table in a storage device and updates search indices on text, time, and speaker fields. The server outputs a stored record identifier and an updated in-memory representation of meeting record data.

### Step 7:

The server determines translation target languages for participants.

The server receives, as input, the stored utterance record and participant profiles retrieved from a user database. The server reads display-language information for each participant and compares it with the language code of the utterance text. The server constructs, for each participant whose display language differs from the utterance language, a translation request that includes source language, target language, and the original character information. The server outputs a set of translation request objects.

### Step 8:

The server performs deterministic machine translation to produce preliminary translations.

The server receives, as input, the translation request objects from Step 7. The server tokenizes the source text according to a vocabulary, encodes the token sequence with an encoder network to produce context representations, and decodes target tokens with a decoder network conditioned on the encoded context and previously generated tokens. The server executes this process for each translation request to generate preliminary translation character information. The server outputs the preliminary translation character information, each linked to the corresponding utterance and target language.

### Step 9:

The server refines translations using a generative AI model guided by a prompt sentence.

The server receives, as input, the original character information, the preliminary translation character information, and context metadata from Steps 6 and 8. The server constructs a prompt sentence that specifies a translation refinement task, such as:

“Translate the following meeting utterance in real time so that participants can immediately understand it, preserving business terminology and cultural nuances.”

The server concatenates the prompt sentence, the original text, and the preliminary translation into a combined input sequence and sends this sequence to a generative AI model. The server receives, as output, refined translation character information that adjusts word choice and phrasing based on context and terminology. The server stores the refined translation character information in the meeting record and marks the translation as refined.

### Step 10:

The server distributes refined translations to relevant terminals.

The server receives, as input, the refined translation character information from Step 9 and the mapping of participants to display languages from Step 7. The server constructs for each participant a message containing the refined translation, source language, target language, and utterance metadata. The server uses a push mechanism via WebSocket or a similar protocol to send the message to the participant's terminal. The server outputs a confirmation that the messages have been queued or delivered.

### Step 11:

The terminal renders translated text and prepares it for speech synthesis.

The terminal receives, as input, a translation message from Step 10. The terminal parses the message and displays the translated text in a user interface with associated speaker and time information. If speech output is enabled, the terminal extracts the translated text and prepares a TTS request object including language code and user-selected voice parameters. The terminal outputs the TTS request object and the corresponding text to a TTS processing module.

### Step 12:

The terminal performs speech synthesis, optionally using a generative AI model for prosody control.

The terminal receives, as input, the translated text and TTS parameters from Step 11. The terminal may construct a prompt sentence for prosody control, such as:

“Convert the following translated meeting text into natural-sounding speech and adjust intonation and rhythm so that questions and emotional emphasis are clearly expressed.”

The terminal sends the translated text and the prompt sentence to a generative AI model configured to output prosody parameters, such as pitch contours and durations, or phoneme-level annotations. The terminal then uses an acoustic model and vocoder to convert the translated text and prosody parameters into a synthesized audio waveform. The terminal outputs the synthesized audio signal to the audio output device for playback to the user.

### Step 13:

The server aggregates utterances into meeting record data.

The server receives, as input, successive utterance records and refined translation character information from Steps 6 and 9. The server orders the utterances by timestamp and assigns sequence numbers. The server combines the fields into a structured meeting record data object that includes original text, refined translations, speaker identifiers, timestamps, and language codes. The server writes the meeting record data to persistent storage and updates indices for efficient retrieval. The server outputs an updated meeting record dataset representing the current state of the meeting.

### Step 14:

The server generates structured meeting minutes using a generative AI model and a prompt sentence.

The server receives, as input, the meeting record dataset from Step 13. The server extracts text segments and metadata for a defined time range or for the entire meeting. The server constructs a minutes-generation prompt sentence, such as:

“Record all utterances during the meeting and organize them into structured, easy-to-search minutes. Summarize main discussion points, decisions, and open issues. Preserve important technical terms and include speaker names and timestamps where relevant.”

The server concatenates the prompt sentence with a formatted representation of the meeting record text and sends this combined input to a generative AI model. The server receives, as output, a structured minutes document containing sections and summaries. The server parses the structured output into minutes data, links it to underlying utterance identifiers, and stores it in the storage device.

### Step 15:

The server extracts tasks and action items from the meeting record data.

The server receives, as input, the meeting record dataset from Step 13. The server applies pattern matching and topic segmentation to identify candidate speech sections likely to contain tasks, such as statements with verbs indicating obligations. The server constructs a task-extraction prompt sentence, such as:

“From the following meeting transcript, automatically extract all tasks and action items. For each item, output the task description, responsible person, due date if mentioned, and priority level. Ignore generic statements that do not imply concrete actions.”

The server sends the candidate speech sections and the prompt sentence to a generative AI model and receives, as output, structured task descriptions. The server normalizes the output into work-item records, resolves participant names to identifiers, interprets relative dates, and stores the resulting task management data in the storage device.

### Step 16:

The server prepares scheduling data and determines candidate meeting times.

The server receives, as input, participant identifiers from the meeting configuration and schedule-management information from connected calendar systems. The server retrieves free-time and time-constraint information for each participant and normalizes all times to a reference time zone. The server computes intersections of free-time intervals across participants and filters intervals by meeting duration and business-hour constraints. The server outputs a set of candidate meeting dates and times with associated availability scores.

### Step 17:

The server selects recommended meeting dates and times using a generative AI model and a prompt sentence.

The server receives, as input, the candidate meeting dates and times and the associated availability scores from Step 16. The server encodes the candidate slots and constructs a scheduling prompt sentence, such as:

“Based on the following free/busy time slots for each participant and their time zones, propose three optimal date-and-time options for the next meeting. Maximize the number of attendees, keep the meeting within local business hours, and avoid national holidays if possible.”

The server sends the encoded candidate slots and the prompt sentence to a generative AI model and receives, as output, a ranked list of recommended meeting date-and-time options. The server verifies that each recommended option satisfies the availability constraints and then selects one or more options as recommended meeting times.

### Step 18:

The server registers schedule information and notifies terminals.

The server receives, as input, the selected recommended meeting times from Step 17 and the participant identifiers. The server creates calendar events through interfaces to external calendar systems, specifying the date, time, duration, and a meeting identifier. The server stores event identifiers in the schedule-management information for each participant. The server then sends notification messages containing the meeting details to the terminals. The terminals receive, as output, the notification messages and display the new meeting schedule to the users.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialogue assistance systems that perform speech recognition, translation, and speech synthesis typically treat these functions as independent modules with fixed behavior. Such systems generally rely on static translation rules and rigid task extraction logic, and store records in unstructured or weakly structured formats. As a result, these systems suffer from several technical limitations in terms of computer technology itself.

First, conventional systems are not designed to dynamically control the behavior of underlying machine learning or generative models by using explicit, context-aware prompt sentences. The translation engine or natural language processing engine often receives only bare text without additional metadata or policy constraints, which leads to suboptimal use of computational resources and produces inconsistent outputs, particularly in domain-specific scenarios such as healthcare or caregiving. This reduces the effectiveness of model inference and forces repeated re-processing, thereby increasing processing latency and server load.

Second, typical record management mechanisms store recognized text and translation results as simple logs, without structuring them according to dialogue units, time information, or semantic segments. This unstructured storage requires expensive, ad hoc search and post-processing operations to retrieve relevant information, which in turn increases memory access overhead and degrades search performance. As the volume of dialogue data grows, the system must scan larger portions of storage to answer user queries, thereby reducing scalability and responsiveness. Third, existing systems that attempt to extract tasks or action items from conversation generally rely on handcrafted rules or fixed statistical models that are not tightly integrated with the rest of the dialogue processing pipeline. When these systems try to incorporate more advanced generative AI models, they typically do so in an ad hoc manner, without a standardized prompt design or structured output handling. This often results in ambiguous outputs that require manual interpretation, which undermines automation of downstream scheduling and task management, and increases computational waste due to repeated correction and re-execution.

Fourth, conventional scheduling modules that derive future appointments from conversational context seldom reuse the structured information already computed by the language processing pipeline, and rarely coordinate tightly with task extraction logic. This separation forces the scheduling module to re-interpret raw text or loosely structured logs, causing redundant parsing, higher CPU utilization, and additional latency, particularly in multi-user, multi-session environments.

Accordingly, there is a need for a system-level architecture and processing method that (i) uses explicit, machine-readable prompt sentences to control generative AI models for translation, summarization, and task extraction; (ii) structures dialogue data in real time by dialogue units and time information for efficient storage and retrieval; and (iii) tightly integrates generative model outputs with task management and schedule management. By addressing these issues as an improvement of the underlying computer processing pipeline, it becomes possible to reduce redundant computation, improve memory access efficiency, and achieve more deterministic and efficient use of generative AI resources in large-scale, real-time communication systems.

The specific processing by the specific processing unit 290 of the data processing device 12 in Application Example 1 is realized by the following means.

The present invention provides a server comprising a processor configured to acquire audio information from one or more client devices, convert the audio information into character information while identifying a language used by a speaker, and structure the character information with associated time information and dialogue-unit identifiers in a storage device; a processor configured to determine a translation target language based on the identified language and a dialogue context, generate a prompt sentence including at least one of a translation policy, a terminology-handling policy, a summarization policy, a task-extraction condition, and an output format, supply the character information together with the prompt sentence to a generative information processing model, and obtain from the model at least one of translated character information, summary information, and structured task information; a processor configured to register, in a database, the acquired character information, the translated character information, and the structured task information in association with the dialogue-unit identifiers and time information so that search operations can be executed using index structures optimized for such associations; and a processor configured to generate task information including at least deadline information, priority information, and person-in-charge information based on the structured task information, to acquire schedule information from an external or internal schedule management information processing device, and to automatically register or update the schedule information according to the generated task information. This enables improvement of the overall computer system performance by reducing redundant natural language processing and scheduling computations, by enforcing consistent and context-aware behavior of generative AI models through explicit prompt sentences, by storing dialogue-related data in a structured and indexable form that reduces search and retrieval overhead, and by tightly integrating task extraction and schedule management so that downstream modules can operate on already-structured data without re-parsing or re-interpretation of raw text.

The term “audio information” refers to time-series data representing sound captured by one or more input devices, including at least analog or digital representations of speech signals to be processed by the system.

The term “character information” refers to digital text data obtained by converting audio information into a sequence of characters or tokens, including recognized words, punctuation, and associated metadata.

The term “language used by a speaker” refers to a natural language, such as a human spoken language, that is identified by the system as the primary linguistic code in which a given portion of audio information or character information is expressed.

The term “dialogue situation” refers to contextual information regarding an ongoing interaction, including at least participant roles, topic, domain, and previously exchanged utterances, used by the system to control subsequent processing.

The term “translation target language” refers to a natural language selected by the system as the language into which character information is to be converted for consumption by another participant or process.

The term “prompt sentence” refers to machine-readable instruction data, including one or more sentences or phrases, supplied as input to a generative information processing model together with content data, and specifying desired processing behavior, constraints, policies, or output format.

The term “translation policy” refers to information included in a prompt sentence that defines how translation should be performed, including at least style, level of formality, preservation of domain-specific terminology, and handling of ambiguity.

The term “terminology-handling policy” refers to information included in a prompt sentence that defines how specific terms, such as domain-specific or technical terms, should be treated during processing, including whether such terms should be preserved, normalized, or expanded.

The term “summarization policy” refers to information included in a prompt sentence that defines how a summary should be generated from dialogue data, including at least the level of detail, length constraints, and emphasis on particular types of information.

The term “task-extraction condition” refers to information included in a prompt sentence that defines criteria by which a generative information processing model is instructed to identify and extract tasks or action items from dialogue data.

The term “output format” refers to a structural specification included in a prompt sentence that defines the representation of data to be produced by a generative information processing model, such as a list, a table, or a structured data format.

The term “generative information processing model” refers to a machine learning model capable of generating or transforming natural language or structured data, based on input content and prompt sentences, including at least generative language models and neural sequence models.

The term “translated character information” refers to character information that has been converted from a source language into a translation target language by the system, optionally including formatting or annotation.

The term “audio profile” refers to a set of parameters that define characteristics of synthesized audio output, including at least voice type, pitch, timbre, speed, and volume.

The term “speech characteristic” refers to temporal and prosodic properties of synthesized or processed speech, including at least intonation, rhythm, stress, and speaking rate.

The term “speaker attributes” refers to information that characterizes a source speaker, including at least gender, age group, role, and preferred style, used to control processing or output generation.

The term “listener attributes” refers to information that characterizes a target listener, including at least age group, hearing condition, language proficiency, and preference for speech style or speed.

The term “dialogue unit” refers to a segment of dialogue, such as an utterance, a turn, or a thematically coherent section, used by the system as a basic unit for structuring, storing, and processing dialogue-related data.

The term “time information” refers to temporal metadata associated with dialogue units or tasks, including at least timestamps, durations, and time intervals.

The term “searchable record” refers to a data structure in which dialogue-related information and associated metadata are stored in a manner that allows queries based on content or metadata to be efficiently executed by search or index mechanisms.

The term “action-request information” refers to information, derived from dialogue or related data, that indicates a requested or implied future action, such as a task to be performed, a check to be conducted, or an appointment to be arranged.

The term “task information” refers to structured data representing a unit of work to be performed, including at least a description, deadline information, priority information, and person-in-charge information.

The term “deadline information” refers to temporal data associated with task information that specifies a due date and/or time by which a task is to be completed.

The term “priority information” refers to data associated with task information that indicates a relative importance or urgency level of a task.

The term “person-in-charge information” refers to data that identifies an individual, role, or entity responsible for performing or supervising a task.

The term “schedule information” refers to data representing planned times and durations of events, tasks, or appointments for one or more users or subject persons.

The term “next execution time” refers to a calculated future time or time interval at which a particular task, event, or care-related action is to be carried out according to system processing.

The term “schedule management information processing device” refers to a computing system or service that manages calendar or schedule information, including at least local calendar programs and remote scheduling services.

The term “dialogue interval” refers to a continuous or logically grouped period of a dialogue, comprising one or more dialogue units, treated as a unit for processing such as summarization.

The term “summary information” refers to character information generated by the system that condenses and abstracts content of one or more dialogue units or dialogue intervals, while preserving salient information according to a summarization policy.

The term “structured task information” refers to task-related data output by a generative information processing model in a predefined structured form, such as key-value pairs, lists, or hierarchical objects, suitable for direct registration as task information.

The term “storage device” refers to any memory or storage apparatus, including volatile and non-volatile media, configured to store dialogue-related data, task information, schedule information, and index data for retrieval.

The term “database” refers to an organized collection of data managed by a database management system, enabling insertion, update, retrieval, and indexing of records including character information, translated character information, summary information, task information, and schedule information.

The term “index structures” refers to data structures maintained by the system to accelerate search and retrieval operations, including at least inverted indexes, B-tree indexes, hash indexes, or specialized text indexes.

The term “client device” refers to any terminal or endpoint device operated by a user or subject person and configured to capture audio information, present output, and communicate with the server.

In one embodiment, the system is implemented as a distributed architecture including a server, one or more terminals, and one or more users. The server comprises at least one processor, a main memory, and a non-volatile storage device, and executes application software on top of an operating system such as a general-purpose server operating system. The terminal comprises a processor, a memory, a microphone, a speaker, a display, and a wireless or wired communication interface, and executes a client application on top of a mobile or desktop operating system. The user operates the terminal to conduct a real-time dialogue, for example in a caregiving or multilingual support context.

The terminal executes application software that controls audio capture and playback, user interface display, and communication with the server. The terminal uses an audio input device, such as a built-in microphone, controlled through an audio input API such as an audio recording interface of the operating system. The terminal also uses an audio output device, such as a built-in speaker, controlled through an audio playback API such as an audio output interface of the operating system. The terminal executes a speech recognition library or service, such as a cloud-based speech recognition API or an on-device automatic speech recognition engine based on an acoustic model and a language model. The terminal converts captured analog audio signals into digital audio samples and processes them to produce character information.

The server executes an application program comprising multiple modules, including at least a speech processing module, a generative AI model integration module, a record management module, a task management module, and a schedule integration module. The server stores dialogue-related data, model outputs, and indexing structures in a database system, which may be a relational database or a document-oriented database. The server further stores trained parameters of a generative AI model, such as a neural network model implementing a sequence-to-sequence architecture with attention or a Transformer architecture.

The terminal converts audio information to character information by applying acoustic feature extraction, such as computing Mel-frequency cepstral coefficients (MFCCs) or log-mel spectrograms, followed by decoding using an acoustic model and a language model. The terminal, for example, uses a recurrent neural network or a Transformer-based acoustic model, and uses a beam search decoder that combines acoustic likelihoods and language model probabilities to output the most likely sequence of words for a given segment of audio. The terminal further identifies the language used by the speaker by computing language identification scores over the recognized text or over acoustic features, and assigns a language code to each segment of character information.

The server receives the character information and associated metadata from the terminal via a network interface using a request-response protocol such as HTTPS. The server stores the received character information and metadata in a structured table or collection. The server assigns a dialogue-unit identifier to each utterance and associates time information, including at least a start time and an end time derived from audio capture timestamps. The server thereby structures the dialogue into discrete dialogue units with defined temporal boundaries and language labels.

The server determines a translation target language for each dialogue unit based on the identified language used by the speaker and a stored dialogue configuration. The server then generates a prompt sentence for a generative AI model. The server constructs the prompt sentence as a concatenation of instruction text and content text, wherein the instruction text specifies, for example, translation policy, terminology-handling policy, summarization policy, task-extraction condition, or output format. For translation, the server may generate a prompt sentence such as: “Translate the following sentence from Japanese to English. Preserve medical and caregiving terminology, and use simple and polite wording suitable for an elderly listener. Sentence: It's time for your medication (in Japanese).”

The server supplies the prompt sentence and the original character information to a generative AI model. In one embodiment, the generative AI model is a Transformer-based sequence-to-sequence neural network with an encoder and a decoder, multiple self-attention layers, and learned positional encodings. The encoder receives tokenized input text and computes contextual representations using multi-head self-attention and feedforward layers. The decoder receives the encoder output and autoregressively generates translated tokens using masked self-attention, encoder-decoder attention, and feedforward layers. The model parameters, including weight matrices and bias vectors for attention and feedforward layers, are stored in the server's storage device and loaded into main memory at runtime.

The server trains the generative AI model offline using a corpus of parallel bilingual text and domain-specific corpora, such as caregiving or medical dialogues. During training, the server minimizes a loss function such as cross-entropy over token predictions, and updates model parameters by gradient-based optimization, such as stochastic gradient descent with adaptive learning rate. The server may use regularization techniques such as dropout, label smoothing, and data augmentation, such as synonym replacement or back-translation, in order to improve generalization and robustness. By training and storing the model weights on the server, the system can execute inference rapidly during online operation without requiring training at runtime.

The server, during inference, processes the prompt sentence and character information by tokenizing text into subword units, such as byte pair encoded tokens, and applying the encoder-decoder network to produce translated character information. The server controls decoding with a beam search algorithm, a length normalization term, and a coverage penalty to balance fluency and adequacy of translated output. The server then reconstructs text from the output tokens into human-readable translated character information and associates it with the original dialogue unit.

The server further uses the generative AI model to perform summarization of dialogue intervals.

The server groups multiple dialogue units into a dialogue interval based on time windows, topic detection, or participant turns. The server generates a prompt sentence such as:

“Summarize the following dialogue between a caregiver and a care receiver. Focus on medication instructions, symptoms, and changes in care plans. Use concise sentences. Dialogue: [list of utterances with timestamps].”

The server supplies this prompt sentence and the concatenated character information for the dialogue interval to the same or another generative AI model that is fine-tuned for summarization. The model, using its neural architecture, computes an abstractive summary by generating new text that captures salient information. The server stores the summary information in association with the dialogue interval in the database and indexes it using text indexes and dialogue-unit identifiers.

The server also uses the generative AI model to extract tasks and action items from dialogue. The server generates a prompt sentence such as:

“From the following conversation, extract all tasks that must be performed in caregiving, such as medication times, health checks, and rehabilitation. For each task, output a description, a due time if specified, and a responsible person. Conversation: [utterances].”

The server inputs this prompt sentence and the relevant dialogue content into the generative AI model and receives structured task descriptions. In one embodiment, the model outputs a structured list in natural language format that contains clear delimiters. The server parses the output by identifying fixed patterns or markers indicated in the prompt, and maps each extracted item to task information fields, including deadline information, priority information, and person-in-charge information. The server then registers each parsed item as task information in a task table linked to the dialogue-unit identifiers and time information.

The server further integrates with a schedule management information processing device, such as a calendar server, to obtain schedule information for the user or a subject person. The server sends requests to obtain free/busy information and existing appointments. The server analyzes the schedule information and the extracted task information to compute a next execution time for each task, for example using algorithms that compare required time windows with available slots.

The server then automatically registers or updates schedule entries in the schedule management information processing device, optionally attaching a description generated by the generative AI model. For example, the server may use a prompt sentence such as:

“Create a clear appointment description for a caregiving session that includes medication administration and a health check. Include date, time, purpose, and simple preparation instructions.”

The server thereby generates text that is stored as an appointment description and displayed on a calendar interface.

The terminal receives translated character information, summary information, or task-related information from the server through the communication interface. The terminal then uses a text-to-speech engine, such as an on-device TTS library or a remote TTS service, to convert translated character information into audio information. The terminal configures an audio profile and speech characteristics based on speaker attributes and listener attributes. For example, for an elderly listener, the terminal sets a slower speaking rate and a reduced pitch range. The terminal uses operating system APIs to control audio output, and to synchronize audio playback with on-screen text display.

The user operates the terminal to initiate and terminate sessions, confirm tasks, inspect summaries, and modify schedule preferences. The user may adjust parameters such as preferred language, preferred speaking rate, or notification thresholds for task reminders. The terminal sends user preferences to the server, which then influences the generation of prompt sentences and the behavior of the generative AI model, for example by specifying language style preferences or detail levels in summarization.

From a technical perspective, the server achieves improved processing efficiency and accuracy by using explicit prompt sentences and structured data flows. The server avoids repeatedly executing generic translation or summarization routines without context; instead, the server encodes domain and user-specific constraints in prompt sentences, which guide the generative AI model to produce outputs that require less post-processing. Because the server structures dialogue data into dialogue units with clearly defined time information and dialogue-unit identifiers, the server can maintain efficient indexes, such as inverted indexes and B-tree indexes, that allow fast retrieval of specific utterances, time ranges, or topic segments. This structured storage reduces the computational cost of search operations compared to unstructured log scanning.

The server further reduces redundant computation by reusing intermediate structures. For example, once the server has computed tokenized representations and stored alignment between audio segments and text segments, downstream modules, such as summarization and task extraction, can operate directly on stored character information and associated metadata without re-decoding audio or re-parsing raw text. This layered architecture, where speech recognition, generation-based language processing, and task/schedule management share common data structures, leads to improved processing speed and reduced memory bandwidth utilization. The generative AI model executed by the server is configured according to specific architectural and training details that distinguish it from conventional static-rule systems. The server uses multi-head attention layers, residual connections, and layer normalization to process long-range dependencies in dialogue text, which allows the model to capture relations between temporally distant utterances. The server optionally uses domain-specific fine-tuning, in which the model is further trained on dialogue data from the target domain, such as caregiving, using the same loss functions but with lower learning rates and regularization tuned for domain adaptation. The server may also apply curriculum learning, in which training examples progress from simple sentences to longer multi-turn dialogues, thereby improving the model's ability to handle complex task extraction prompts.

The server defines non-conventional processing rules for parsing model outputs and integrating them with data structures. For instance, for task extraction, the server includes in the prompt a custom pseudo-markup scheme, such as using specific keywords and delimiters around tasks, that are not typical of human conversation. The server then parses this pseudo-markup deterministically, mapping each segment to database fields. This technique allows the server to convert unstructured natural language output into structured task information without relying solely on probabilistic post-processing. This non-standard usage of prompt design and parsing logic constitutes a specialized data-processing method that improves the determinism and reliability of generative model outputs in a multi-user, multi-session environment.

The system also achieves technical improvements in terms of communication load. Because the server is responsible for heavy generative processing, the terminal can send compressed, structured character information and metadata, rather than raw audio streams, in many cases. Even when raw audio is required, the terminal can segment and filter audio locally, removing silent intervals and noise, thereby reducing the amount of data transmitted. The structuring of dialogue into dialogue units with time information allows the server to send incremental updates and partial results to the terminal, which reduces round-trip latency and allows the terminal to update its user interface without re-downloading entire sessions.

In an alternative embodiment, the terminal performs a larger portion of the processing locally. For example, the terminal may host a smaller generative AI model with reduced parameter size, such as a compressed Transformer model, and execute translation or summarization locally. In such a case, the server primarily stores and indexes structured records and provides synchronization across multiple terminals. The same principles of prompt sentence design, structured data storage, and task/schedule integration apply, but model inference is executed on the terminal's processor, which may be a mobile system-on-chip with a neural processing unit. This embodiment can reduce server load and network dependency while still providing structured records and coordinated schedule management.

In another embodiment, the server integrates multiple generative AI models specialized for different tasks, such as one model for translation, one model for summarization, and one model for structured task extraction. The server routes incoming dialogue units and prompt sentences to the appropriate model based on task type, and then merges the outputs into coherent records. The server may implement a model selection algorithm that evaluates model performance metrics or domain tags and chooses an optimal model instance for each request. By modularizing model usage and routing requests at a fine-grained level, the server can achieve better computational efficiency and flexibility, adapting to different domains or load conditions.

The described embodiments show that the system is not limited to abstract manipulation of text. The terminal and server cooperate to control physical devices, such as microphones, speakers, displays, and calendar devices, and to adjust signal processing parameters, such as audio sampling, TTS prosody parameters, and network transmission strategies. The system uses specific data structures and algorithms, including neural network architectures, prompt-based control, indexing schemes, and deterministic parsing rules, to improve processing speed, accuracy, and resource utilization. By structuring dialogue data and integrating generative AI outputs with task and schedule management, the system improves the operation of the computer itself, enabling more efficient and reliable processing than conventional pipelines that treat translation, summarization, and task extraction as separate, unstructured activities.

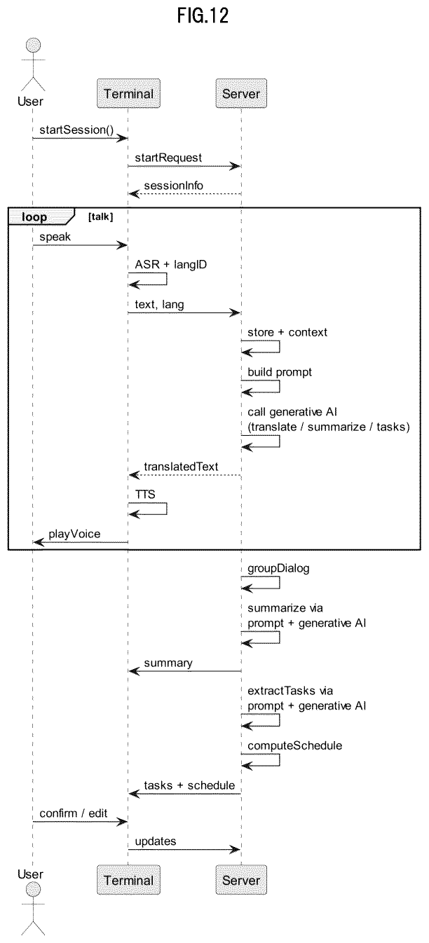

The following describes the processing flow using FIG. 12.

### Step 1:

The user operates the terminal to start a dialogue session.

The terminal receives as input a user operation, such as tapping a “Start Session” button and optional settings including participant roles, preferred languages, and audio profile parameters. The terminal processes this input by generating a session-start request object that includes a unique device identifier, user identifier, selected languages, and device capability information. The terminal outputs the session-start request to the server via a network interface.

### Step 2:

The server receives the session-start request from the terminal.

The server takes as input the request object containing user identifiers, language preferences, and device information.

The server processes this input by allocating a new session identifier, initializing dialogue metadata (participants, source and target languages, time of start), and creating session records in a database table.

The server outputs a session-initialization response containing the session identifier, confirmed language mapping, and configuration parameters back to the terminal.

### Step 3:

The terminal begins capturing audio information for the active session.

The terminal takes as input the session-initialization response and microphone signals from an audio input device.

The terminal processes the audio input by sampling analog signals into digital audio frames, applying pre-processing such as noise reduction and voice activity detection, and segmenting continuous audio into utterance segments based on detected speech boundaries.

The terminal outputs pre-processed audio segments with associated timestamps and speaker labels to its local speech recognition module.

### Step 4:

The terminal performs speech recognition and language identification.

The terminal takes as input each pre-processed audio segment with timestamps.

The terminal processes this input by computing acoustic features (for example, MFCCs or log-mel spectrograms), passing them through an acoustic model and language model, and performing beam search decoding to generate the most probable text sequence. The terminal further computes a language identification score to determine the language used by the speaker.

The terminal outputs character information for each utterance, along with language code, confidence score, speaker label, and time information.

### Step 5:

The terminal transmits recognized character information to the server.

The terminal takes as input the character information and associated metadata generated in Step 4.

The terminal processes this input by packaging the data into a structured request object containing the session identifier, dialogue-unit identifier, original text, language code, and timestamps, and by optionally compressing or batching multiple utterances to reduce communication overhead.

The terminal outputs the packaged recognition data to the server over a secure network connection.

### Step 6:

The server stores and structures the received character information.

The server takes as input the packaged recognition data from the terminal.

The server processes this input by parsing the request object, validating the session identifier, and inserting records into storage structures that associate each dialogue unit with a session identifier, speaker label, language code, and time information. The server also updates in-memory indexes or queues to reflect the arrival of new dialogue units.

The server outputs structured dialogue-unit records and confirmation of successful storage, which may be logged or used by downstream modules.

### Step 7:

The server determines a translation target language and prepares translation context.

The server takes as input a structured dialogue-unit record including the identified source language and session configuration.

The server processes this input by consulting session metadata to map the source language to a translation target language, retrieving relevant domain information (for example, caregiving domain flag) and any user-specific preferences (formal level, terminology behavior), and constructing a translation context object.

The server outputs a translation context that specifies source language, translation target language, domain tags, and style preferences for the next processing step.

### Step 8:

The server generates a translation-oriented prompt sentence for the generative AI model.

The server takes as input the translation context and the original character information of a dialogue unit.

The server processes this input by concatenating instruction phrases and content phrases into a single prompt sentence, incorporating translation policy and terminology-handling policy. For example, the server may generate:

“Translate the following sentence from Japanese to English. Preserve medical and caregiving terminology, and use simple and polite wording suitable for an elderly listener. Sentence: It's time for your medication (in Japanese).”

The server outputs the constructed prompt sentence together with the original character information as the input payload for a translation generative AI model.

### Step 9:

The server executes translation inference using the generative AI model.

The server takes as input the prompt sentence and associated text content from Step 8.

The server processes this input by tokenizing the text into subword units, forwarding the token sequence through the encoder-decoder neural network, computing attention-based contextual representations, and performing beam search decoding over the target language vocabulary to generate translated tokens. The server then reconstructs the translated character information by detokenizing the output tokens into human-readable text.

The server outputs translated character information linked to the original dialogue-unit identifier and language codes.

### Step 10:

The server stores translated character information and updates dialogue records.

The server takes as input the translated character information and the original structured dialogue-unit record.

The server processes this input by adding translation-specific fields to the record in the database, such as translation text, translation target language, and translation confidence, and by updating text indexes to include both original and translated text for later search and retrieval.

The server outputs an updated dialogue-unit record and a response message containing the translated character information and metadata to be returned to the terminal.

### Step 11:

The terminal receives the translated character information and prepares audio output.

The terminal takes as input the server response containing translated character information and associated attributes, such as target language and priority.

The terminal processes this input by queuing the translated character information for playback, selecting an audio profile and speech characteristic settings (voice type, speed, pitch) based on listener attributes, and generating a text-to-speech configuration object.

The terminal outputs a TTS-ready text string and configuration parameters to its text-to-speech engine.

### Step 12:

The terminal performs text-to-speech synthesis and playback.

The terminal takes as input the translated character information and the TTS configuration parameters from Step 11.

The terminal processes this input by invoking a TTS engine, converting the text into an internal phoneme or acoustic representation, synthesizing a digital waveform using a parametric or neural TTS model, and sending the resulting audio samples to the audio output interface.

The terminal outputs synthesized audio information to the speaker so that the user or subject person hears the translated utterance.

### Step 13:

The server groups dialogue units into dialogue intervals for summarization.

The server takes as input multiple structured dialogue-unit records associated with the same session and time range.

The server processes this input by clustering dialogue units based on time proximity, topic similarity, or participant roles, and by creating dialogue interval objects that contain an ordered list of dialogue units and associated time information.

The server outputs dialogue interval objects that are candidates for summarization.

### Step 14:

The server generates a summarization prompt sentence and executes summarization.

The server takes as input a dialogue interval object comprising multiple dialogue units.

The server processes this input by concatenating the text of the dialogue units into a single content block and generating a summarization prompt sentence that includes a summarization policy and items to be emphasized, for example: “Summarize the following dialogue between a caregiver and a care receiver. Focus on medication instructions, symptoms, and changes in care plans. Use concise sentences. Dialogue: [utterances with timestamps].”

The server then tokenizes the prompt and content, feeds them to a generative AI model fine-tuned for summarization, and decodes the output tokens to obtain summary information.

The server outputs the summary information associated with the corresponding dialogue interval. Step 15:

The server stores summary information and updates searchable records.

The server takes as input summary information and the dialogue interval identifier.

The server processes this input by inserting the summary into a summary table and linking it to the corresponding dialogue interval and session, and by updating full-text indexes to include summary text. This data processing allows the system to answer later queries by searching both original dialogues and summaries.

The server outputs an updated set of records in storage and makes the summary available for retrieval by the terminal.

### Step 16:

The server performs task extraction from dialogue content.

The server takes as input a sequence of dialogue-unit records from a session that may contain actionable instructions.

The server processes this input by constructing a task-extraction prompt sentence that includes a task-extraction condition and an output format, such as:

“From the following conversation, extract all tasks that must be performed in caregiving, such as medication times, health checks, and rehabilitation. For each task, output a description, a due time if specified, and a responsible person. Conversation: [utterances].”

The server sends the prompt and dialogue content to a generative AI model specialized for structured extraction, receives natural language output containing task descriptions, and parses the output according to predetermined markers or patterns defined in the prompt.

The server outputs a set of structured task candidates that include at least task description, deadline, and responsible person.

### Step 17:

The server registers and manages task information.

The server takes as input structured task candidates derived in Step 16.

The server processes this input by validating each candidate (checking for duplicate tasks, normalizing date and time expressions, mapping names to user identifiers), assigning priority levels based on rules or context, and storing each validated task as task information in a task table associated with session and dialogue-unit identifiers.

The server outputs persistent task information records that can be retrieved, updated, and linked to schedule information.

### Step 18:

The server integrates task information with schedule information.

The server takes as input task information, including deadline and responsible person, and external schedule information obtained from a schedule management information processing device.

The server processes this input by computing a next execution time for each task through comparison of required time windows and available schedule slots, applying constraints such as maximum daily workload and user preferences, and generating proposed appointments or schedule updates.

The server outputs proposed schedule entries for each task, which may be automatically registered in the schedule management device or presented to the user for confirmation.

### Step 19:

The terminal presents summaries, tasks, and schedule proposals to the user.

The terminal takes as input summary information, task information, and proposed schedule entries received from the server.

The terminal processes this input by rendering text summaries in the user interface, organizing tasks in lists sorted by priority and deadline, and displaying calendar views or notifications for proposed schedule entries. The terminal may also generate spoken summaries or read out tasks using text-to-speech based on user settings.

The terminal outputs visual and/or audio presentations that enable the user to review and confirm the results of the processing.

### Step 20:

The user confirms, modifies, or rejects tasks and schedule entries.

The user takes as input the presented summaries, task lists, and schedule proposals on the terminal.

The user processes this information by selecting tasks, changing statuses (such as marking tasks as completed), editing due times, or accepting or rejecting proposed appointment times through the terminal interface.

The terminal outputs updated task and schedule modification requests to the server, which then updates task information and schedule information accordingly, completing the processing loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In network-based multilingual meeting environments, conventional systems typically perform a pipeline of speech recognition, machine translation, and text-to-speech synthesis using fixed models and static parameter settings. These conventional architectures are generally optimized to maximize literal accuracy of transcription and translation, but they are not configured to dynamically adapt to speaker emotion, meeting context, or business-appropriate tone. As a result, several technical problems arise.

First, conventional systems treat emotion, if used at all, as an auxiliary annotation that is not deeply integrated into the core processing flow. Acoustic emotion recognition and text-based sentiment analysis, when implemented separately, are not jointly fused at the utterance level in real time. Without a systematic fusion of acoustic feature-based emotion scores and text-based emotion scores, the system cannot robustly estimate emotion labels and intensities under varying noise conditions, microphone qualities, and speaking styles. This limitation leads to unstable downstream behavior, such as inconsistent tone in synthesized speech and inappropriate emphasis in translated text, which degrades the usability and reliability of the communication system itself.

Second, conventional multilingual meeting systems generally use rule-based or fixed-style translation models that do not exploit the full capability of modern generative AI models controlled via prompt sentences. These systems do not formulate structured prompt sentences that simultaneously specify: (i) the semantic preservation requirement, (ii) the desired politeness and calmness suitable for business communication, and (iii) explicit control of emotional nuance based on fused emotion information. As a result, the translation output is often either overly literal and emotionally flat, or overly expressive and inappropriate in tone, causing misalignment between the speaker's intent and the system's output.

Third, conventional text-to-speech control in such systems is typically limited to static or heuristic parameter settings (e.g., fixed pitch or speaking rate), without leveraging a generative AI model to design speech synthesis parameters dynamically for each utterance. In particular, existing systems do not generate speech synthesis parameter sets (pitch, speaking rate, volume, and pause length) through prompt-controlled optimization that takes into account both the original emotion profile and the business context. This leads to monotonous synthesized audio that fails to convey appropriate nuance or, conversely, to excessive emotional expression that is unsuitable for professional use.

Fourth, in post-meeting processing, conventional systems generate meeting minutes, task lists, and follow-up agendas using primarily textual content, without deeply integrating emotion information derived from both acoustic and textual signals. Traditional minutes generation tools do not accept structured meeting utterance data and emotion metadata as input to a generative AI model, and thus cannot highlight emotionally important issues, such as topics associated with high anxiety or confusion. Similarly, conventional task extraction and next-meeting planning functions do not use emotion-aware prompt sentences to extract tasks with burden indicators or to propose follow-up agenda items focused on emotionally problematic topics. This omission results in suboptimal prioritization of post-meeting actions and inhibits the system's ability to support efficient project management and meeting design.

From a computer technology standpoint, these limitations manifest as an inability to fully exploit the representational and controllability capabilities of generative AI models in a structured, prompt-driven pipeline integrated with acoustic feature processing and multimodal emotion fusion. The absence of a processor configured to (i) build and use specific prompt sentences at multiple pipeline stages, (ii) consistently propagate fused emotion information through translation, speech synthesis, and analytics, and (iii) generate structured outputs (minutes, tasks, schedules) that leverage this emotion information, results in a technically inferior system in terms of adaptability, expressiveness control, and overall system-level effectiveness.

Accordingly, there is a need for a system and server-side processing architecture in which a processor is specifically configured to: generate meeting utterance information including acoustic features and text; compute and fuse multimodal emotion scores; generate prompt sentences for emotion-aware translation; generate prompt sentences for speech synthesis parameter design; and generate prompt sentences for minutes summarization, task extraction, and next-agenda proposal. Such a system should provide improved control of translation tone, speech synthesis parameters, and post-meeting analytics, thereby technically improving the operation of the underlying computer-implemented communication system.

The specific processing by the specific processing unit 290 of the data processing device 12 in Example 2 is realized by the following means.

The present invention provides a server comprising a processor configured to obtain, from an information processing apparatus used by a meeting participant, an audio signal of a spoken utterance, perform speech recognition processing on the audio signal to convert the audio signal into text information, extract from the audio signal acoustic feature information including at least pitch, energy, spectral characteristics, silence interval information, and speaking rate, and generate meeting utterance information including the text information, the acoustic feature information, speaker information, and language information; input the acoustic feature information into a machine learning model to calculate first emotion scores, input the text information and a prompt sentence that specifies emotion estimation content and output format into a generative AI model to calculate second emotion scores, and integrate the first emotion scores and the second emotion scores with predetermined weighting to determine, for each utterance, emotion information including an emotion label and an emotion intensity; generate a translation prompt sentence that specifies processing content and output format for generating translation text which preserves a semantic content of the text information, is expressed in a polite and calm style appropriate for business communication, and controls an emotional nuance based on the emotion information, and input the translation prompt sentence and the text information into the generative AI model to generate, as an output of the generative AI model, translation text in a target language and an emotion profile including tone information corresponding to the emotion information; generate a speech synthesis parameter generation prompt sentence for causing the generative AI model to propose speech synthesis parameters including at least pitch, speaking rate, volume, and pause length of a synthesized speech, input the speech synthesis parameter generation prompt sentence and the translation text into the generative AI model to obtain the speech synthesis parameters, and transmit the speech synthesis parameters and the translation text to the information processing apparatus used by the meeting participant; and store, on a recording medium and on a per-meeting basis, the meeting utterance information, the emotion information, and the translation text, generate a minutes summarization prompt sentence that specifies viewpoints and output format for summarizing meeting minutes using stored information, and input the minutes summarization prompt sentence and the stored information into the generative AI model to generate minutes summary data that reflects emotion tendencies in each agenda item and emotion-important discussion points; and optionally further configured to generate a task extraction prompt sentence for extracting work items decided during a meeting and generating task information including at least task content, assignee information, deadline information, and emotion information related to each work item based on the meeting utterance information and the emotion information, input the task extraction prompt sentence and the meeting utterance information and the emotion information into the generative AI model to obtain the task information, assign, to each task included in the task information, a management attribute indicating at least a burden degree or an anxiety degree of an assignee based on the emotion information included in the task information, and perform list display or priority control of the tasks in accordance with the management attribute; and optionally further configured to use, after completion of a meeting, the meeting utterance information, the minutes summary data, and the emotion information as input, generate a next-agenda proposal prompt sentence for extracting discussion points with high anxiety or confusion of participants and generating candidate agenda items and reasons therefor for a next meeting, input the next-agenda proposal prompt sentence and the meeting utterance information and the emotion information into the generative AI model to obtain agenda proposals for the next meeting, and generate, based on the agenda proposals and schedule information of the participants obtained from a schedule management system, combinations of candidate date-time slots and agenda items for the next meeting and present the combinations to the participants. This enables a computer-implemented multilingual meeting support system to perform integrated, prompt-driven control of emotion-aware translation, speech synthesis parameter design, minutes generation, task management, and next-meeting planning, thereby improving the technical operation of the underlying computing environment by dynamically adapting text, audio, and post-meeting analytics to fused multimodal emotion information in real time.

The term “information processing apparatus” refers to an electronic device including at least a processor, a memory, and an input/output interface, and configured to execute software for capturing audio, transmitting and receiving data via a network, and presenting information to a user.

The term “audio signal” refers to time-series data representing sound, including at least digitized waveform data obtained by sampling a physical acoustic signal captured by a microphone.

The term “speech recognition processing” refers to computational processing that converts an audio signal of spoken language into machine-readable text information by analyzing acoustic characteristics and mapping them to linguistic units using a recognition model.

The term “text information” refers to digital data representing linguistic content in a character or token sequence form that can be processed, stored, or displayed by a computing system.

The term “acoustic feature information” refers to numerical data derived from an audio signal, including at least pitch, energy, spectral characteristics, silence interval information, and speaking rate, and used as input for machine learning or statistical analysis.

The term “pitch” refers to a quantitative representation of the perceived fundamental frequency of a voiced segment in an audio signal, typically expressed as a numerical value or frequency.

The term “energy” refers to a quantitative measure of signal intensity in an audio signal, typically computed as a power or root-mean-square value over a time window.

The term “spectral characteristics” refers to numerical values derived from the frequency distribution of an audio signal, including at least features such as spectral centroid, spectral bandwidth, or cepstral coefficients.

The term “silence interval information” refers to data indicating time regions in an audio signal during which speech activity is absent or below a threshold, including at least durations and positions of such intervals.

The term “speaking rate” refers to a quantitative measure indicating a rate of speech, such as a number of linguistic units per unit time within an utterance.

The term “meeting utterance information” refers to structured data associated with a spoken utterance in a meeting, including at least text information, acoustic feature information, speaker information, and language information.

The term “speaker information” refers to data that identifies or distinguishes a speaker in a meeting, such as a user identifier, device identifier, or pseudonymous label.

The term “language information” refers to data indicating a natural language associated with an utterance, such as a language code specifying a source language or a target language.

The term “machine learning model” refers to a computational model comprising parameters obtained through a training process using example data, and configured to output prediction results such as emotion scores based on input feature information.

The term “emotion scores” refers to numerical values representing estimated probabilities, intensities, or degrees of one or more emotion categories for a given utterance.

The term “emotion label” refers to a categorical identifier of an emotion assigned to an utterance, such as anger, joy, sadness, anxiety, or neutral, determined based on emotion scores.

The term “emotion intensity” refers to a numerical value indicating a strength or magnitude of a particular emotion label associated with an utterance.

The term “prompt sentence” refers to a text string that instructs a generative AI model regarding a desired processing task, constraints, or output format, and that is supplied as part of an input to the generative AI model.

The term “generative AI model” refers to a machine learning model configured to generate textual or structured outputs, such as translations, parameter sets, summaries, task lists, or agenda proposals, in response to input text and a prompt sentence.

The term “first emotion scores” refers to emotion scores computed by the machine learning model based on acoustic feature information derived from an audio signal.

The term “second emotion scores” refers to emotion scores computed by the generative AI model based on text information and a prompt sentence specifying emotion estimation.

The term “emotion information” refers to metadata associated with an utterance and including at least an emotion label and an emotion intensity obtained by integrating first emotion scores and second emotion scores.

The term “translation prompt sentence” refers to a prompt sentence that specifies processing content and output format for generating translation text, including at least requirements regarding semantic preservation, tone style, and emotion control.

The term “translation text” refers to text information that represents a translation of source text into a target language, generated by the generative AI model under control of a translation prompt sentence.

The term “target language” refers to a natural language into which source text is translated by the generative AI model.

The term “emotion profile” refers to data associated with translation text and including at least tone information and emotion-related attributes derived from emotion information.

The term “tone information” refers to data indicating a desired style or manner of expression in text or synthesized speech, such as calm, formal, concerned, or neutral.

The term “speech synthesis parameter generation prompt sentence” refers to a prompt sentence that instructs a generative AI model to propose values of speech synthesis parameters, including at least pitch, speaking rate, volume, and pause length.

The term “speech synthesis parameters” refers to control values used by a text-to-speech engine to determine characteristics of synthesized speech, including at least pitch, speaking rate, volume, and pause length.

The term “pause length” refers to a time duration parameter indicating a length of a silent interval to be inserted before, after, or between synthesized speech segments.

The term “recording medium” refers to any tangible or non-transitory storage medium that can store digital information, including at least semiconductor memory, magnetic storage, or optical storage.

The term “minutes summary data” refers to data representing a summarized form of meeting content, including at least key points and emotion-related information for each agenda item or discussion topic.

The term “minutes summarization prompt sentence” refers to a prompt sentence that specifies viewpoints and output format for generating minutes summary data from meeting utterance information and emotion information.

The term “task extraction prompt sentence” refers to a prompt sentence that instructs a generative AI model to identify work items decided during a meeting and to generate corresponding task information based on meeting utterance information and emotion information.

The term “task information” refers to structured data representing a work item, including at least task content, assignee information, deadline information, and emotion information related to the work item.

The term “assignee information” refers to data indicating a responsible person or entity for a task, such as a user identifier or role.

The term “deadline information” refers to data indicating a due date or time by which a task is to be completed.

The term “management attribute” refers to a control attribute associated with a task and indicating at least a burden degree or an anxiety degree of an assignee, used for list display or priority control.

The term “next-agenda proposal prompt sentence” refers to a prompt sentence that instructs a generative AI model to extract discussion points associated with high anxiety or confusion and to generate candidate agenda items and reasons therefor for a next meeting.

The term “agenda proposals” refers to proposed agenda items for a future meeting, including at least titles or descriptions of topics and associated reasons for follow-up.

The term “schedule management system” refers to an information system configured to manage and provide schedule information for users, including at least free/busy information or calendar entries.

The term “schedule information” refers to data representing availability or planned events of participants, obtained from a schedule management system.

The term “candidate date-time slots” refers to proposed time intervals at which a future meeting may be held, determined based on schedule information of participants.

The term “processor” refers to a hardware computing element, such as a central processing unit or other computation circuitry, configured to execute instructions and perform the operations described in the claims.

In the following embodiments, server, terminal, and user cooperate to implement the claimed system.

Server denotes one or more server-class information processing devices.

Terminal denotes an information processing device operated by user, such as a mobile terminal or personal computer.

### 1. Hardware and Software Configuration

Server uses a general-purpose server-class computer including at least one multi-core processor, a main memory, a non-transitory storage device, and a network interface.

Server executes an operating system such as a general-purpose server operating system and application server software implemented using a server framework.

Server further executes a machine learning framework such as a neural network framework (for example, a framework for deep learning) and a generative AI model execution environment that allows server to send prompt sentences and receive generated text.

Terminal uses an information processing device such as a smartphone, tablet, or notebook computer including a processor, a memory, a built-in microphone, a built-in speaker or headphone output, a display, and a wireless or wired network interface.

Terminal executes a general-purpose operating system such as a smartphone operating system or a desktop operating system.

Terminal further executes a multilingual meeting application, an audio input API, an audio processing library such as an audio processing library for real-time communication, an on-device speech recognition library such as an open-source speech recognition library, an acoustic feature extraction library such as a general-purpose audio analysis library, and a text-to-speech engine such as a platform-standard TTS engine or a neural TTS SDK.

User operates terminal to access the system, speak in a native language, and receive translated voice output or translated text output.

### 2. Data Structures and Overall Modules

Server uses a relational database or a key-value database to store at least the following records:

Server stores, as meeting utterance information, for each utterance:
(i) text information as a character sequence,
(ii) acoustic feature information as a numerical vector including at least pitch, energy, spectral characteristics, silence interval information, and speaking rate,
(iii) speaker information such as a user identifier,
(iv) language information such as a source language code and a target language code, and
(v) timestamps indicating start and end times.

Server stores emotion information per utterance, including an emotion label and an emotion intensity.

Server stores translation text in association with each utterance and target language.

Server stores minutes summary data, task information, and agenda proposals as separate structured records.

Server implements, as software modules:
(i) an acoustic emotion inference module implemented with a neural network,
(ii) a prompt sentence generation module for emotion estimation, translation, speech synthesis parameter generation, minutes summarization, task extraction, and next-agenda proposal,
(iii) a generative AI client module that communicates with a generative AI model,
(iv) a fusion module that integrates first emotion scores and second emotion scores, and
(v) a controller that coordinates storage and communication to and from terminals.

This modular structure allows server to process large numbers of meeting utterances in parallel and to reuse intermediate results (such as emotion information) across translation, speech synthesis, and analytics. As a result, computing resources are more efficiently used and redundant computations are reduced, which directly improves processing throughput and latency.

### 3. Acoustic Feature Extraction and Emotion Modeling

Terminal uses an audio processing library to perform noise suppression, echo cancellation, and automatic gain control on PCM audio data captured by the microphone.

Terminal then uses an audio analysis library to compute acoustic feature information in a deterministic, frame-based manner.

Terminal computes, for each analysis frame, a short-time Fourier transform, from which spectral characteristics such as spectral centroid and log-mel filterbank energies are calculated.

Terminal computes MFCCs by applying a discrete cosine transform to log-mel energies.

Terminal computes pitch by applying a periodicity-based estimator or an autocorrelation-based estimator on the time-domain signal.

Terminal computes energy as the root-mean-square of the frame's amplitude.

Terminal determines silence frames by comparing energy and voicing measures against predefined thresholds.

Terminal aggregates these frame-level features into utterance-level statistics (for example, mean, variance, and min/max values).

By designing this feature vector to be fixed-length and normalized, server can apply a standard neural network model for acoustic emotion inference, which significantly reduces the dimensionality and noise of raw audio data and improves inference speed and stability compared with directly operating on waveforms.

Server uses a neural network for acoustic emotion inference, for example a network with several fully connected layers and non-linear activation functions such as rectified linear units.

Server configures the network to take as input the normalized acoustic feature vector and to output, at its final layer, a set of logits corresponding to a plurality of emotion categories.

Server applies a softmax function to the logits to obtain first emotion scores representing probability-like values.

Server trains this acoustic emotion network offline using supervised learning.

Server uses a training dataset of audio segments labelled with emotion categories and optionally intensity annotations.

Server defines a loss function such as a cross-entropy loss between predicted scores and label distributions.

Server updates network weights by stochastic gradient descent or a variant such as Adam.

Server optionally applies techniques such as batch normalization, dropout, or data augmentation (for example, adding noise, pitch shifting, and speed perturbation) to improve generalization. This design allows the acoustic emotion inference to be robust to noise and speaker variability, and to run efficiently at inference time due to the moderately sized network and low-dimensional features, which improves the technical performance of the system compared with conventional rule-based or purely heuristic emotion detectors.

### 4. Text-Based Emotion Analysis by Generative AI Model

Server uses a generative AI model such as a large-scale transformer-based language model that supports prompt-driven generation.

Server communicates with this model through an API, sending prompt sentences and context text and receiving structured or natural language outputs.

Server constructs a prompt sentence that instructs the model to output emotion scores in a specified JSON-like textual format. Example:

“You are an assistant that analyzes emotions in business meeting utterances.

Estimate which emotions (anger, joy, sadness, anxiety, neutral) are expressed in the following utterance, and output scores between 0.0 and 1.0 for each label in JSON format.

Utterance text: ‘I'm concerned that this schedule makes the project quite tight (in Japanese).’”

Server sends this prompt sentence and the utterance text as input tokens to the generative AI model.

Server receives the generated output as a text sequence, parses the numeric values, and obtains second emotion scores.

Server uses the combination of deterministic acoustic emotion inference and context-sensitive text-based emotion inference to obtain more reliable emotion information.

Because the generative AI model can take into account preceding utterances or meeting context, it can disambiguate phrases that are emotionally neutral acoustically but carry anxiety or concern in the semantic content.

By fusing the two sources, server reduces both false positives and false negatives in emotion detection, which improves downstream translation tone selection and speech synthesis parameter selection.

### 5. Multimodal Emotion Fusion

Server uses a fusion module that takes as input first emotion scores (from the acoustic model) and second emotion scores (from the generative AI model) for each utterance.

Server normalizes the scores if necessary and applies a weighted linear combination using pre-configured weights that can be tuned per meeting type or per environment.

For example, server computes, for each emotion category c:

final_score(c)=w_acoustic·first_score(c)+w_text·second_score(c)

where w_acoustic and w_text are scalar weights that sum to one.

Server then selects as the emotion label the category with the maximum final_score and sets the emotion intensity to that maximum value.

Server stores this emotion information as metadata associated with the utterance.

By explicitly defining this fusion rule, server ensures deterministic and consistent behavior that is not achievable by a purely heuristic or human-driven decision.

Moreover, because the fusion is implemented as simple vector arithmetic on pre-computed scores, it is computationally lightweight and can operate in real time even for large multi-party meetings, thereby improving system responsiveness.

### 6. Emotion-Aware Translation Using Prompt Sentences

Server uses the fused emotion information, along with source text and language information, to generate a translation prompt sentence that constrains the generative AI model's behavior.

Server constructs a translation prompt sentence that specifies:
(i) the role of the model as a simultaneous interpretation assistant,
(ii) the input language and target language,
(iii) the speaker's primary emotion label and intensity,
(iv) the requirement to preserve semantic content,
(v) the requirement to produce a polite and calm expression appropriate for business, and
(vi) the requirement to control emotional nuance within a limited range.

### Example Translation Prompt Sentence:

“You are a simultaneous interpretation assistant for multilingual business meetings.

Translate the following Japanese utterance into English.

The speaker's primary emotion is ‘anxiety’ with intensity 0.78.

Preserve enough nuance so that the listener can sense the speaker's concern, but adjust the wording to remain polite, calm, and appropriate for a business meeting.

Output only the English translation sentence.

Japanese utterance: ‘I'm concerned that this schedule makes the project quite tight (in Japanese).’”

Server sends the translation prompt sentence and the source text to the generative AI model.

Server receives translation text such as “I'm concerned that this schedule makes the project quite tight.”

By carefully specifying in the prompt sentence both emotional and tonal constraints, server transforms the generative AI model from a generic text generator into a controlled translation function that yields consistent, business-appropriate outputs.

This improves translation quality not just in terms of semantic fidelity but also in terms of tone alignment, which is a technical improvement in the behavior of the computer-implemented translation system compared with uncontrolled generative text.

### 7. Emotion Profile and Speech Synthesis Parameter Design

Server derives an emotion profile from the emotion label and intensity, such as “calm_but_concerned” for high anxiety but business-calibrated expression.

Server then constructs a speech synthesis parameter generation prompt sentence that instructs the generative AI model to output numeric values for speech synthesis parameters.

### Example Prompt Sentence:

“You are an assistant for designing parameters of a text-to-speech system.

The following English utterance occurs in a business meeting, and the speaker is estimated to feel ‘anxiety’ with intensity 0.78.

Design parameters so that the utterance is spoken in a tone that is calm but slightly anxious.

Avoid exaggerated emotional expression and prioritize clarity and professionalism.

Output JSON with the four fields: ‘pitch’ (0.5-1.5), ‘rate’ (0.5-1.5), ‘volume’ (0.5-1.5), ‘pause_after_sentence’ (seconds).

English utterance: ‘I'm concerned that this schedule makes the project quite tight.’”

Server sends this prompt sentence and translation text to the generative AI model, and receives proposed values for pitch, speaking rate, volume, and pause length.

Server then converts these values into parameters used by the specific TTS engine on terminal.

For example, server maps pitch to a relative pitch parameter, maps rate to a speechRate parameter, and so on.

This approach constitutes more than mere automation of human tuning because server uses a structured, non-conventional procedure: it uses emotion information, forms a specialized prompt sentence, and uses the generative AI model to solve a multi-parameter design problem conditioned on utterance content and emotional profile.

By offloading parameter design to a generative AI model that is guided by precise constraints, server can achieve more consistent and contextually appropriate prosody across many speakers and languages. This improves intelligibility and listener comfort while maintaining low computation and control overhead on terminal, which is a technical improvement in the text-to-speech control pipeline.

### 8. Minutes Summarization and Post-Meeting Analytics Using Prompt Sentences

Server stores, in a recording medium, the meeting utterance information, emotion information, and translation text.

Server organizes this data into sequences per meeting and optionally groups utterances by topic using time segments or agenda labels.

Server then constructs a minutes summarization prompt sentence that explains to the generative AI model the structure of the input data and the required output format. Example:

“You are an assistant for summarizing meeting minutes.

Below is a chronological list of utterances from a business meeting, each with an emotion tag (anger, joy, anxiety, neutral, etc.) and an emotion score.

Based on these Data:
1. For each agenda item, summarize the main points and indicate whether participants were mostly positive or negative.
2. List up to three points where ‘anxiety’ or ‘confusion’ was particularly strong.
3. For each such point, propose what follow-up actions should be taken in the next meeting.

Output in Japanese, using bullet list format.

### [Meeting Data Inserted Here]”

Server sends this prompt sentence and the compiled meeting data to the generative AI model. Server receives a structured textual summary that incorporates emotion trends and important points, and stores it as minutes summary data.

By constructing explicit prompt sentences that integrate both textual content and emotion metadata, server ensures that the generative AI model uses non-standard, multi-criteria decision rules that differ from conventional human summarization and from simple keyword extraction. This allows the system to prioritize emotionally charged topics, improving the technical function of a meeting analysis tool by making follow-up decisions more data-driven and less arbitrary.

### 9. Task Extraction and Management with Emotion-Based Attributes

Server uses meeting utterance information and emotion information to construct a task extraction prompt sentence. Example:

“You are an assistant for extracting action items from meeting transcripts.

Based on the following meeting utterances and their emotion data,
1. Extract all tasks decided during the meeting.
2. For each task, identify the responsible person, due date (if mentioned), and whether the responsible person expressed anxiety or a sense of burden.
3. Output the result in JSON format.

### [Meeting Data Inserted Here]”

Server sends this prompt sentence and meeting data to the generative AI model and receives textual task descriptions with assignee and deadline.

Server then maps these tasks into an internal task information structure and computes a management attribute for each task based on the associated emotion information.

For example, server sets a high burden flag when the emotion intensity associated with the assignee's utterance exceeds a threshold.

Server uses this management attribute to control display order, highlight tasks, or adjust notification policies.

This approach is technically distinct from human manual task recording because server uses a multi-step computational pipeline: structured input, emotion fusion, prompt-guided extraction, emotion-based attribute computation, and UI control.

As a result, the system can automatically prioritize tasks that are both important and emotionally heavy for participants, improving clarity and reducing the chance of oversight in project-critical items.

### 10. Next-Agenda Proposals and Schedule Integration

Server uses meeting utterance information, minutes summary data, emotion information, and participant schedule information obtained from an external schedule management system to construct a next-agenda proposal prompt sentence. Example:

“You are a meeting design assistant.

Based on the following transcript and emotion data (emotion tags and scores for each utterance) from the previous meeting:
1. Identify topics where participants' anxiety or confusion was particularly high.
2. Propose three agenda items for the next meeting to follow up on those topics.
3. For each agenda item, briefly explain which emotional trends justify the follow-up.

Output in Japanese, using bullet list format.

### [Meeting Data Inserted Here]”

Server sends this prompt sentence and meeting data to the generative AI model and obtains agenda proposals.

Server then performs an algorithmic intersection of participants' free/busy slots to determine candidate date-time combinations with maximal attendance.

Server stores and presents these combinations to user through a web interface or through terminal.

By linking emotion-aware analysis with objective schedule constraints, server enables a computation that is not achievable through a simple “calendar plus text” automation. The system uses a specific decision rule: it selects future topics based on emotion scores and arranges them in time slots maximizing participant availability. This improves utilization of communication resources and reduces the need for manual negotiation of meeting times and topics.

### 11. Technical Effects and Improvement of Computer Technology

Server and terminal cooperate to implement a tightly integrated, prompt-driven pipeline over multimodal data. This architecture produces several technical improvements:

Server reduces network bandwidth and latency by performing acoustic feature extraction and initial speech recognition on terminal, transmitting compact feature vectors and text, rather than raw audio streams. This leads to improved real-time behavior for geographically distributed participants.

Server improves accuracy and robustness of emotion estimation by combining a dedicated acoustic neural network and a large-scale text-based generative AI model through explicit score fusion. This multimodal fusion reduces classification errors and stabilizes emotional labels under noisy conditions, directly improving the quality of subsequent translation and speech synthesis control.

Server improves computational efficiency and responsiveness by reusing emotion information for multiple downstream tasks (translation, TTS parameter design, minutes summarization, task extraction, next-agenda proposal), avoiding redundant analysis and enabling parallelization.

Server improves the functioning of the generative AI model as a computing component by providing specialized prompt sentences tied to structured input data. The generative AI model, when controlled via these prompt sentences, operates as a configurable algorithmic module that satisfies determinable constraints (for example, output format, tone, parameter ranges), transforming it from a generic text generator into a predictable subsystem within the larger computing pipeline.

Terminal improves audio capture quality using tailored pre-processing, which enhances speech recognition and acoustic emotion inference performance, and reduces error rates. This, in turn, reduces the need for retransmissions and manual corrections, thus improving the overall reliability of the communication network.

User benefits from smoother, more natural translated audio and more accurate, emotion-aware minutes and task management, but the core improvement resides in the internal operation of the computing system itself: lower latency, improved resource utilization, reduced error propagation, and higher robustness in noisy real-world environments.

### 12. Variations and Alternative Embodiments

Server can implement the machine learning model for acoustic emotion inference using different neural architectures, such as convolutional neural networks, recurrent neural networks, or transformer-based encoders operating on sequences of frame-level features.

Server can implement the generative AI model as a locally hosted model or as a remote service accessed over a secure network protocol.

Terminal can perform all acoustic feature extraction locally, as described, or can offload part of the feature computation to server when terminal computing resources are limited.

Server can adjust weight coefficients in the fusion of first and second emotion scores dynamically based on measured noise levels or recognized language.

Server can also adapt prompt sentence templates according to meeting type (for example, project review versus sales call) or domain (for example, technical engineering versus legal discussion), by changing the specified tone, politeness level, or output structure.

These modifications show that the claimed system is not limited to a single configuration but can be implemented with equivalent architectures while preserving the distinctive technical approach of multimodal emotion fusion and prompt-driven control of a generative AI model across translation, speech synthesis, and meeting analytics.

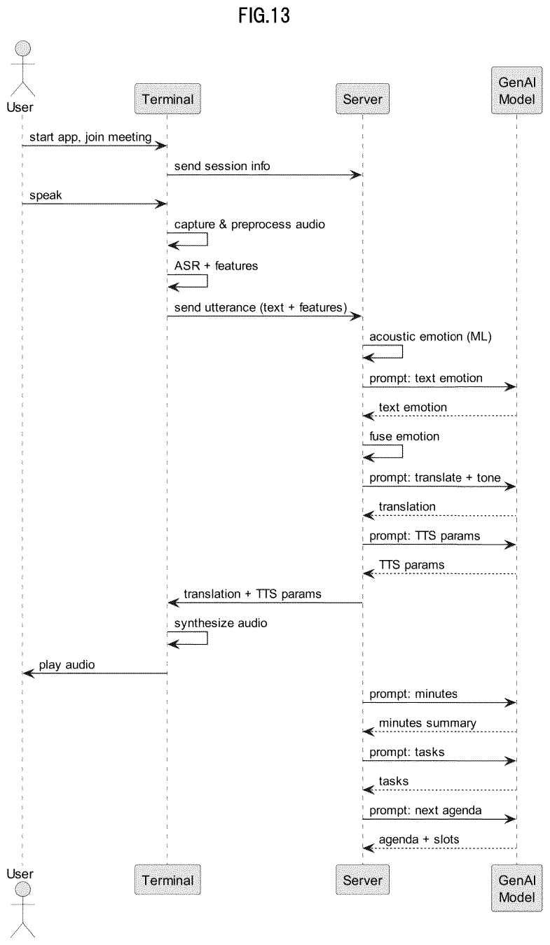

The following describes the processing flow using FIG. 13.

### Step 1:

User starts a multilingual meeting session.

User operates terminal to launch a multilingual meeting application and inputs a meeting identifier, user name, and language preferences (input language and output language) via a graphical user interface.

Input: user's keystrokes and touch events indicating meeting identifier, user name, and language settings.

Terminal reads these UI inputs, creates a user profile data structure containing a speaker identifier, input language code, output language code, and preferred speech synthesis style, and stores this profile in local memory.

Output: user profile object held by terminal and ready to be transmitted.

### Step 2:

Terminal sends session setup information to server.

Input: user profile object generated in Step 1.

Terminal serializes the user profile into a structured message (for example, JSON) and uses a networking library to send this message to server over a secure connection such as HTTPS or WebSocket.

Server receives the message via its network interface, parses the serialized data, and registers the user in a session management table in a database, associating the user identifier with the meeting identifier and a connection handle.

Output: server-side session record linking user, meeting, and connection, and terminal in a joined state.

### Step 3:

User speaks, and terminal captures raw audio.

User speaks toward the built-in microphone of terminal in the user's native language.

Input: analog acoustic signal produced by user's speech.

Terminal uses an operating system audio input API to sample the analog signal at a fixed sampling rate (for example, 16 kHz) and bit depth (for example, 16-bit), producing frames of PCM audio data with timestamps.

Terminal stores these PCM frames in a short-term audio buffer in memory for subsequent processing.

Output: time-stamped PCM audio frame sequence representing user's utterance.

### Step 4:

Terminal applies audio preprocessing.

Input: PCM audio frames from Step 3.

Terminal calls functions of an audio processing library (for example, a library for noise suppression, echo cancellation, and automatic gain control) to process each PCM frame.

Terminal removes steady background noise, reduces echo by using a reference of recent speaker output, and normalizes signal amplitude to a target level.

Terminal concatenates the processed frames and updates timestamps to maintain alignment.

Output: preprocessed PCM audio frame sequence with reduced noise and echo, suitable for recognition and feature extraction.

### Step 5:

Terminal performs speech recognition and language identification.

Input: preprocessed PCM audio frames from Step 4.

Terminal uses an on-device speech recognition library and first runs a lightweight language identification algorithm on an initial portion of the audio, computing language probabilities from acoustic characteristics and possibly character n-gram patterns from partial recognition.

Terminal selects a language-specific acoustic model and language model according to the most probable language code.

Terminal then feeds successive audio frames into the recognition decoder, which computes acoustic likelihoods, performs decoding (for example, using a beam search), and outputs partial recognition hypotheses.

Terminal detects end of utterance based on a period of silence and finalizes the recognition result as text information along with start time and end time.

Output: recognized text string, source language code, start timestamp, and end timestamp for the utterance.

### Step 6:

Terminal extracts acoustic feature information.

Input: preprocessed PCM audio frames from Step 4 and utterance timing (start and end timestamps) from Step 5.

Terminal segments the PCM audio according to utterance start and end times and divides the segment into analysis frames (for example, 25 ms window with 10 ms hop).

Terminal uses an audio analysis library to compute, for each frame, pitch using an F0 estimation algorithm, energy as RMS amplitude, spectral characteristics via a short-time Fourier transform (such as spectral centroid and log-mel features), and MFCCs via discrete cosine transform of log-mel energies.

Terminal marks frames as silence or speech using thresholds on energy and voicing.

Terminal aggregates frame-level values into utterance-level statistics such as mean, variance, and min/max, and computes speaking rate by dividing the number of recognized units (for example, syllables or tokens in the text) by utterance duration.

Output: acoustic feature information vector including pitch, energy, spectral characteristics, silence interval information, and speaking rate for the utterance.

### Step 7:

Terminal constructs and sends meeting utterance information to server.

Input: recognized text, language code, timestamps from Step 5, acoustic feature vector from Step 6, and user profile (speaker identifier).

Terminal combines these data into a meeting utterance information structure containing text information, acoustic feature information, speaker information, and language information.

Terminal serializes this structure into a message format and transfers the message to server via a networking client library, monitoring for transmission errors and retrying when necessary.

Server receives the message, validates its structure, and writes the contained fields into a meeting utterances table in a database.

Output: meeting utterance information stored on server and ready for emotion analysis.

### Step 8:

Server computes first emotion scores from acoustic feature information.

Input: acoustic feature information associated with an utterance from Step 7.

Server normalizes the feature vector according to pre-computed training statistics stored in memory (for example, subtracting feature means and dividing by feature standard deviations).

Server inputs the normalized vector to a neural network model for acoustic emotion inference implemented using a deep learning framework.

Server performs a forward pass through the network's layers, computing activations and final logits for each emotion category.

Server applies a softmax function to the logits to produce first emotion scores representing a probability distribution over predefined emotion labels.

Output: first emotion scores per emotion category for the utterance.

### Step 9:

Server computes second emotion scores using a generative AI model and a prompt sentence.

Input: text information from Step 7.

Server constructs a prompt sentence instructing a generative AI model to analyze the emotion of a business meeting utterance and to output scores for defined emotion labels.

### Example Prompt Sentence:

“You are an assistant that analyzes emotions in business meeting utterances.

Estimate which emotions (anger, joy, sadness, anxiety, neutral) are expressed in the following utterance, and output scores between 0.0 and 1.0 for each label in JSON format.

Utterance text: ‘I'm concerned that this schedule makes the project quite tight (in Japanese).’”

Server sends this prompt sentence and the utterance text as input to the generative AI model via an API call and waits for the model's generated output.

Server receives the output as a text sequence, parses numeric values corresponding to each emotion label, and assembles them into second emotion scores.

Output: second emotion scores per emotion category for the utterance.

### Step 10:

Server fuses first and second emotion scores to obtain emotion information.

Input: first emotion scores from Step 8 and second emotion scores from Step 9.

Server aligns the two score vectors by emotion label and computes a weighted combination for each label using a predetermined weighting scheme, for example computing a linear combination of the two sets of scores.

Server determines, for each emotion label, a final score and selects the label with the highest final score as the emotion label for the utterance.

Server uses the highest final score as the emotion intensity.

Server forms an emotion information structure including the emotion label and emotion intensity and stores it in association with the utterance record in the database.

Output: emotion information (emotion label and intensity) for the utterance.

### Step 11:

Server generates a translation prompt sentence and performs emotion-aware translation using a generative AI model.

Input: text information and language information from Step 7, and emotion information from Step 10.

Server constructs a translation prompt sentence that specifies the role of the generative AI model, the source and target languages, the speaker's emotion label and intensity, and the requirement for business-appropriate tone and controlled nuance.

### Example Prompt Sentence:

“You are a simultaneous interpretation assistant for multilingual business meetings.

Translate the following Japanese utterance into English.

The speaker's primary emotion is ‘anxiety’ with intensity 0.78.

Preserve enough nuance so that the listener can sense the speaker's concern, but adjust the wording to remain polite, calm, and appropriate for a business meeting.

Output only the English translation sentence.

Japanese utterance: ‘I'm concerned that this schedule makes the project quite tight (in Japanese).’”

Server sends this prompt sentence with the source text to the generative AI model and receives translation text in the target language.

Server records the translation text and constructs an emotion profile that describes tone information (for example, calm but concerned) derived from the emotion information.

Output: translation text in the target language and an emotion profile corresponding to the utterance.

### Step 12:

Server generates speech synthesis parameters using a generative AI model and a prompt sentence.

Input: translation text and emotion profile from Step 11.

Server constructs a speech synthesis parameter generation prompt sentence that instructs the generative AI model to output numeric parameter values for pitch, speaking rate, volume, and pause length consistent with the specified emotional tone and business context.

### Example Prompt Sentence:

“You are an assistant for designing parameters of a text-to-speech system.

The following English utterance occurs in a business meeting, and the speaker is estimated to feel ‘anxiety’ with intensity 0.78.

Design parameters so that the utterance is spoken in a tone that is calm but slightly anxious.

Avoid exaggerated emotional expression and prioritize clarity and professionalism.

Output JSON with the four fields: ‘pitch’ (0.5-1.5), ‘rate’ (0.5-1.5), ‘volume’ (0.5-1.5), ‘pause_after_sentence’ (seconds).

English utterance: ‘I'm concerned that this schedule makes the project quite tight.’”

Server sends this prompt sentence and the translation text to the generative AI model and receives a textual description of parameter values.

Server parses the returned values, validates ranges, and converts them into a speech synthesis parameter set compatible with the TTS engine specification of terminal.

Output: speech synthesis parameter set including pitch, speaking rate, volume, and pause length adapted for the utterance.

### Step 13:

Server transmits translation text and speech synthesis parameters to terminal.

Input: translation text and speech synthesis parameter set from Step 12, as well as mapping between speaker and recipient terminals from session data.

Server constructs a delivery message including at least the translation text, speech synthesis parameters, utterance identifiers, and timing information.

Server sends this message to terminal over an established communication channel, optionally generating different translation texts for different output languages for different recipients.

Output: message received by terminal containing translation text and associated speech synthesis parameters.

### Step 14:

Terminal performs speech synthesis and outputs translated audio.

Input: translation text and speech synthesis parameter set from Step 13, and local user's output language settings.

Terminal configures its text-to-speech engine by setting pitch, speaking rate, volume, and pause-related options according to the received parameter values.

Terminal sends the translation text to the TTS engine, which generates audio samples representing synthesized speech.

Terminal sends the synthesized speech samples to the audio output API, which drives the speaker or headphones.

User hears the other participant's utterance in the preferred language with prosody adjusted according to the processed emotion profile and business context.

Output: audible translated speech output to user.

### Step 15:

Server stores meeting utterance information, translation text, and emotion information for later analysis.

Input: meeting utterance information from Step 7, translation text from Step 11, and emotion information from Step 10.

Server updates its database to link each utterance with its corresponding translation text and emotion information, storing these data on a per-meeting basis.

Server may additionally generate index entries or summary statistics for quick retrieval and analysis.

Output: persistent per-meeting records of utterances, translations, and emotion metadata.

### Step 16:

Server constructs a minutes summarization prompt sentence and generates minutes summary data.

Input: aggregated meeting utterance information, translation texts, and emotion information from Step 15.

Server arranges these data chronologically and groups them by topic or agenda where available.

Server constructs a minutes summarization prompt sentence describing the structure of the input and requesting specific summary elements such as sentiment by agenda and high-anxiety topics.

### Example Prompt Sentence:

“You are an assistant for summarizing meeting minutes.

Below is a chronological list of utterances from a business meeting, each with an emotion tag (anger, joy, anxiety, neutral, etc.) and an emotion score.

Based on these Data:
1. For each agenda item, summarize the main points and indicate whether participants were mostly positive or negative.
2. List up to three points where ‘anxiety’ or ‘confusion’ was particularly strong.
3. For each such point, propose what follow-up actions should be taken in the next meeting.

Output in Japanese, using bullet list format.

### [Meeting Data Inserted Here]”

Server sends this prompt sentence and the compiled meeting data to the generative AI model, receives a summary text, and saves it as minutes summary data in the database.

Output: minutes summary data reflecting content and emotion trends of the meeting. Step 17:

Server constructs a task extraction prompt sentence and generates task information.

Input: meeting utterance information and emotion information from Step 15.

Server compiles relevant utterances into an input context and constructs a task extraction prompt sentence instructing the generative AI model to identify work items, assignees, deadlines, and emotional burden.

### Example Prompt Sentence:

“You are an assistant for extracting action items from meeting transcripts.

Based on the following meeting utterances and their emotion data,
1. Extract all tasks decided during the meeting.
2. For each task, identify the responsible person, due date (if mentioned), and whether the responsible person expressed anxiety or a sense of burden.
3. Output the result in JSON format.

### [Meeting Data Inserted Here]”

Server sends the prompt sentence and meeting data to the generative AI model, receives descriptions of tasks, and then maps them into task information records including task content, assignee information, deadline information, and associated emotion information.

Server computes a management attribute such as burden degree or anxiety degree for each task based on the emotion intensity and assigns it to the task record.

Output: structured task information with management attributes stored in the database.

### Step 18:

Server constructs a next-agenda proposal prompt sentence and generates agenda proposals for the next meeting.

Input: meeting utterance information, minutes summary data, and emotion information from Step 15 and Step 16, and participant schedule information from an external schedule management system.

Server prepares meeting data highlighting topics with high anxiety or confusion and constructs a next-agenda proposal prompt sentence instructing the generative AI model to propose agenda items focusing on those topics.

### Example Prompt Sentence:

“You are a meeting design assistant.

Based on the following transcript and emotion data (emotion tags and scores for each utterance) from the previous meeting:
1. Identify topics where participants' anxiety or confusion was particularly high.
2. Propose three agenda items for the next meeting to follow up on those topics.
3. For each agenda item, briefly explain which emotional trends justify the follow-up.

Output in Japanese, using bullet list format.

### [Meeting Data Inserted Here]”

Server sends this prompt sentence and the meeting data to the generative AI model and receives candidate agenda items with reasons.

Server then intersects participant availability slots from the schedule management system and selects combinations of candidate date-time slots and agenda items that maximize attendance. Server stores these combinations and makes them available to terminals or a web interface for user review.

Output: candidate next-meeting agenda proposals and corresponding date-time options generated and stored by server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional multilingual speech translation systems typically perform a linear pipeline of automatic speech recognition, machine translation, and text-to-speech synthesis. Such systems generally treat user utterances as neutral text and ignore acoustic and contextual emotional information. As a result, they cannot adjust translation style, prosody, or system behavior according to the user's emotional state, cognitive state, or vulnerability. In domains such as caregiving and other high-stakes interpersonal services, this limitation leads to several technical problems.

First, existing systems usually treat speech recognition, translation, and logging as separate components, often implemented as independent services. Conversation logs, if stored, are typically plain text or unstructured transcripts lacking synchronized emotional annotations. Consequently, it is difficult or impossible for downstream modules to automatically and reliably infer high-priority tasks, safety-critical events, or optimal scheduling from the recorded data. Human operators must manually read the text, interpret subtle emotional cues and context, and then perform secondary operations such as task management or schedule planning, which is time-consuming, error-prone, and highly dependent on individual skill.

Second, many current systems that attempt to incorporate emotion use simple sentiment scores or heuristic rules tied directly to raw model outputs. They do not integrate multiple heterogeneous signals (for example, acoustic features and linguistic context) in a robust manner, nor do they exploit large generative AI models through structured prompt sentences to refine or contextualize emotion estimates. This results in unstable or inconsistent emotion classification, particularly in noisy environments, code-switching conversations, or emotionally nuanced dialogue. As a consequence, any emotion-dependent adaptation of translation style or speech synthesis parameters is often crude and unreliable.

Third, even when generative AI models are used, they are often invoked in an ad hoc manner, without a well-defined architecture that binds model interactions to a coherent, machine-actionable data structure. For instance, generative models may be used only for free-form summarization, without creating structured outputs that downstream components (such as task planners or scheduling engines) can consume deterministically. This lack of structure limits the ability of the computer system to automatically transform multimodal conversation data into actionable, prioritized tasks and feasible schedule candidates under real-world constraints.

Fourth, task extraction and schedule proposal processes in many existing systems are either fully manual or heavily reliant on separate planning tools that are loosely coupled to the communication interface. These tools often lack synchronized access to granular conversation and emotion records. As a result, they cannot leverage detailed emotional trajectories, utterance-level cues, or pattern-level statistics (such as typical times of day when a given user is more stable or more distressed). This separation leads to suboptimal use of computational resources, fragmented data, and limited automation, which in turn prevents the system from systematically improving scheduling and resource allocation.

Accordingly, there is a need for an integrated computer-implemented system that: (i) acquires user speech and converts it into structured character string data; (ii) computes multimodal features and determines a robust final emotional state by combining neural classification with context-aware refinement by a generative AI model via explicit prompt sentences; (iii) uses the final emotional state to control both linguistic expression style and speech synthesis parameters; (iv) persistently records, in a structured and time-aligned manner, original text, translated and style-adjusted text, emotional states, and output parameters as conversation record data; and (v) automatically generates structured task lists and feasible schedule candidates by feeding the conversation record data and schedule constraints, together with designed prompt sentences, into a generative AI model and post-processing the structured outputs. There is a particular need to design such a system as an improvement in computer technology, in which coordinated use of generative AI models, prompt sentences, and structured data representations yields more reliable, scalable, and automated computation than prior pipelines that treat each function in isolation and rely on human interpretation for downstream task and schedule management.

The specific processing by the specific processing unit 290 of the data processing device 12 in Application Example 2 is realized by the following means.

The present invention provides a server comprising a processor configured to acquire audio data transmitted from an information processing terminal that captures speech of a user, convert the speech content into character string data, extract feature values from the character string data and from the audio data, estimate an emotional state of the user based on the feature values, generate conversation history data and acoustic feature summary data together with a predetermined prompt sentence, input the conversation history data, the acoustic feature summary data, and the predetermined prompt sentence to a generative AI model, obtain a context-based correction of the emotional state from the generative AI model, integrate the correction result with the estimation result based on the feature values, and determine a final emotional state; convert the character string data into other character string data in a language different from a language of the user; generate, in accordance with the final emotional state and attribute information of the user, a prompt sentence including, as input text, the other character string data obtained by the conversion, input the prompt sentence and the input text to the generative AI model, obtain, from the generative AI model, adjusted character string data in which an expression style including at least one of sentence length, vocabulary difficulty, use of honorific expressions, and presence or absence of reassuring expressions is adjusted, and/or change the expression style by rule-based processing based on the final emotional state; determine, based on the adjusted character string data and the final emotional state, speech synthesis parameters representing at least one of speech rate, pitch, prosody, volume, and speaker profile, generate speech synthesis data including the adjusted character string data and the speech synthesis parameters, and transmit the speech synthesis data to the information processing terminal; store, in association on a time-series basis, at least the character string data, the converted other character string data, the adjusted character string data, the final emotional state, the speech synthesis parameters, and corresponding time information and speaker information as conversation record data; input, as text data, at least a part of the conversation record data and a prompt sentence to the generative AI model, obtain task information including at least a content of a future work item to be executed, a responsible party category, a priority, and a reason why the work item is required, and generate a task list based on the task information; analyze emotional states stored in the conversation record data and care schedule information, calculate at least an emotional tendency by time slot and a compatibility index between the user and a caregiver, generate text data describing analysis results and future schedule constraint information together with a prompt sentence, input the text data and the prompt sentence to the generative AI model, obtain from the generative AI model a plurality of schedule proposals including candidate next care execution dates and times and candidate caregivers, compare the plurality of schedule proposals with the schedule constraint information, calculate feasible candidates for next care execution dates and times, and cause the information processing terminal to execute speech synthesis processing based on the speech synthesis data and to present the task list and the feasible candidates for next care execution dates and times in a displayable and operable format. This enables a computer-implemented architecture in which multimodal emotion estimation, generative-model-driven expression control, structured conversation recording, task extraction, and schedule calculation are tightly integrated so that the system, rather than human operators, automatically transforms raw conversation audio into emotion-aware translations, prioritized machine-actionable tasks, and constraint-compliant schedule candidates, thereby improving the technical functioning, reliability, and scalability of multilingual communication and workflow management on computing platforms.

The term “audio data” refers to digital data representing a time-varying acoustic signal obtained by sampling and quantizing an analog sound signal, such as a user's speech captured by a microphone of an information processing terminal.

The term “information processing terminal” refers to an electronic apparatus having at least a processor, a memory, a user interface, a microphone, a speaker, and a communication interface, the electronic apparatus being configured to capture user speech, transmit audio data to a server, receive data from the server, and present information by at least display and/or audio output.

The term “character string data” refers to text information obtained by encoding speech content or translation results according to a predetermined character code scheme, and including at least a sequence of characters representing linguistic content.

The term “feature values” refers to numerical or symbolic values derived from at least one of audio data and character string data, including, for example, acoustic features such as pitch, energy, speaking rate, and silence duration, and linguistic features such as word embeddings, sentence embeddings, and keyword indicators.

The term “emotional state” refers to information indicating a psychological or emotional condition of a speaker, including at least an emotion category, such as anxiety, anger, sadness, confusion, complaint of pain, or relief, and an intensity value represented by a numerical score.

The term “conversation history data” refers to structured data representing a sequence of utterances exchanged between at least two participants, each utterance being associated with at least character string data, time information, and speaker information.

The term “acoustic feature summary data” refers to data describing, in a condensed form, one or more acoustic characteristics extracted from audio data for one or more utterances, including at least representative values of pitch, energy, speaking tempo, or silence segments.

The term “prompt sentence” refers to text data that specifies, for a generative AI model, a processing task, conditions, constraints, and/or desired output format, and that is input together with other data such as conversation history or feature summaries to guide the model's output.

The term “generative AI model” refers to a machine-learned model trained on large amounts of data and configured to generate output data such as text in response to input data and a prompt sentence, the model being capable of tasks such as context-aware emotion refinement, text rewriting, task extraction, and schedule proposal.

The term “context-based correction of the emotional state” refers to an adjustment of an initially estimated emotional state by considering surrounding utterances, acoustic patterns, and semantic context, the adjustment being produced by a generative AI model based on conversation history data and acoustic feature summary data.

The term “final emotional state” refers to an emotional state determined by integrating at least an initial estimation result based on feature values and a context-based correction result obtained from a generative AI model.

The term “translation” or “convert the character string data into other character string data in a language different from a language of the user” refers to processing that transforms character string data expressed in a first natural language into character string data expressed in a second natural language different from the first natural language.

The term “expression style” refers to one or more attributes characterizing the way in which content is expressed in text, including at least sentence length, vocabulary difficulty, grammatical politeness level, and presence or absence of phrases that provide reassurance.

The term “adjusted character string data” refers to character string data whose expression style has been modified in accordance with at least an emotional state and/or attribute information of a user, by using a generative AI model and/or rule-based processing.

The term “attribute information of the user” refers to information related to properties of a user, such as age group, language proficiency, role (for example, caregiver or care recipient), or other profile information used to determine expression style or output parameters.

The term “speech synthesis parameters” refers to control values used by a text-to-speech process to generate audio signals, the control values including at least speech rate, pitch, prosody pattern, volume level, and a speaker profile identifier.

The term “speech synthesis data” refers to data provided to an information processing terminal for generating synthetic speech, and including at least character string data to be spoken and associated speech synthesis parameters.

The term “speaker profile” refers to data specifying characteristics of a synthetic voice, such as gender type, age type, timbre, accent type, or other voice qualities, used to select or configure a speech synthesis voice.

The term “time information” refers to data indicating a time point or time interval associated with an utterance or processing step, including at least timestamps for start and end of an utterance.

The term “speaker information” refers to data indicating an identity, role, or category of a speaker associated with an utterance, such as whether the speaker is a caregiver, a care recipient, or another participant.

The term “conversation record data” refers to data stored in a storage device in association on a time-series basis, the data including at least character string data, translated character string data, adjusted character string data, emotional states, speech synthesis parameters, time information, and speaker information for each utterance.

The term “task information” refers to structured data describing at least one work item to be executed, including at least a task content description, a responsible party category, a priority, and a reason why the work item is required.

The term “responsible party category” refers to a classification indicating which type of person or role is to perform a work item, such as caregiver, nurse, physician, family member, or system operator.

The term “priority” refers to information indicating a relative importance or urgency level of a work item, represented, for example, by discrete levels such as high, medium, and low, or by numerical scores.

The term “task list” refers to a collection of task information entries managed as structured data, each entry including at least a task content description, a responsible party category, a priority, and optionally a reason and status information.

The term “care schedule information” refers to data related to planning and constraints for providing care services, including at least past care session dates and times, user appointments, caregiver shift schedules, and facility operational constraints.

The term “emotional tendency by time slot” refers to a statistical pattern of emotional states of a user aggregated over different time periods, such as specific times of day or days of the week, indicating, for example, relative stability or volatility of emotions across time slots.

The term “compatibility index between the user and a caregiver” refers to a quantitative or qualitative indicator derived from historical conversation record data that reflects how interactions between a particular user and a particular caregiver affect emotional states, such as whether emotions tend to be more stable when that pair interacts.

The term “schedule constraint information” refers to data representing conditions that must be satisfied when scheduling care sessions, including at least caregiver availability, user availability, and facility operation rules.

The term “schedule proposals” refers to candidate plans for future care sessions generated by a generative AI model, each plan including at least a candidate execution date and time and a candidate caregiver, and optionally explanatory information.

The term “feasible candidates for next care execution dates and times” refers to those schedule proposals that satisfy schedule constraint information, such as caregiver shift schedules and facility operation conditions, and that are selected by the system as viable options for actual scheduling.

The term “displayable and operable format” refers to a representation of information on a user interface of an information processing terminal that allows a user to visually confirm the information and to perform operations such as selection, confirmation, modification, or completion input through user interface elements.

In one embodiment, a server, a plurality of terminals, and one or more users cooperate to implement the present invention. The server includes at least one central processing unit (CPU), at least one graphics processing unit (GPU), a main memory, a non-volatile storage device, and a network interface. The server executes a server operating system, such as a general-purpose server OS based on a UNIX-like system, and executes application programs providing speech recognition, feature extraction, emotion estimation, translation, expression adjustment, speech output control, recording, task extraction, and schedule calculation. The terminal includes at least a processor, a memory, a display, a microphone, a speaker, and a wireless or wired communication interface, and executes a mobile operating system (for example, a general-purpose mobile OS) and an application configured to communicate with the server. The terminal captures speech of a user via the microphone using an audio API provided by the mobile operating system, for example, an audio capture class in a common mobile platform. The terminal converts the analog speech signal into digital audio data in linear PCM format with a predetermined sampling frequency (e.g., 16 kHz) and bit depth (e.g., 16 bits). The terminal stores the audio samples in a ring buffer in the memory, segments the stream into fixed-length frames or chunks, attaches timestamps obtained from the OS clock, and attaches speaker type metadata indicating, for example, whether the speaker is a caregiver or a care recipient. The terminal transmits the audio chunks and associated metadata to the server using a secure network protocol such as HTTPS or WebSocket over Transport Layer Security (TLS). By using chunked transmission, the terminal reduces peak memory usage and allows the server to begin processing while additional audio is still being captured, improving end-to-end latency.

The server receives the audio chunks through a web application framework such as a server-side Python or JavaScript framework. The server parses the incoming messages, verifies a session identifier, and stores the audio chunks into a session-specific buffer in the main memory. The server normalizes the audio amplitude, and, if necessary, resamples the data to match the input specification of a speech recognition model. The server uses a digital signal processing library, such as a general-purpose audio analysis library, to compute time-frequency features. In one example, the server uses a short-time Fourier transform window of 25 ms with a 10 ms hop size and computes 80-dimensional log-mel filter bank coefficients from the magnitude spectra. The server arranges the resulting features into tensors of shape (time steps, feature dimension) and transfers them to the GPU memory.

The server executes a multilingual automatic speech recognition model, such as an encoder-decoder transformer model similar to known large-scale speech models, implemented in a deep learning framework, such as a general-purpose tensor computation library. The model includes a stack of self-attention and feed-forward layers in the encoder, and a similar stack in the decoder with cross-attention to the encoder outputs. The server performs inference by feeding the feature tensor to the encoder, then performing autoregressive decoding in the decoder to produce a sequence of token probabilities. The server decodes the tokens into character string data using a vocabulary and language-specific token mapping. The server simultaneously obtains a language identifier output by the model. The server stores the recognized text, the language code, and associated timestamps and speaker information as utterance records in the main memory.

The server extracts feature values from the audio data and from the character string data. The server computes acoustic features using an audio analysis library. The acoustic features may include, for each utterance, a mean and variance of the fundamental frequency (pitch), short-time energy, spectral centroid, speaking rate estimated by segmenting the waveform into voiced and unvoiced regions, and silence duration before and after the utterance. The server converts the text into vector representations by applying a pretrained text encoder, such as a transformer-based language model implemented in a deep learning framework. The text encoder maps each token to an embedding vector and uses multi-head self-attention to compute a contextual representation.

The server obtains, for example, a fixed-length sentence embedding by pooling the hidden states (e.g., taking the [CLS] token representation or averaging all token representations). The server may also compute keyword indicators by matching against predefined lexicons for pain, anxiety, or other domain-specific expressions.

The server concatenates or otherwise combines the acoustic feature vector and the textual embedding vector into a unified feature vector for each utterance. The server inputs the unified feature vector into an emotion classification neural network. In one embodiment, the emotion classification neural network is a multilayer perceptron including an input layer, two or more hidden layers with rectified linear unit activation functions, and an output layer producing logits for each emotion category. The server trains the network in advance using supervised learning on labeled dialogue data. The server defines a cross-entropy loss function between the predicted class probabilities and ground-truth labels, and uses a stochastic gradient descent or adaptive gradient optimization algorithm to update the weights. During training, the server may apply data augmentation to the audio (e.g., adding background noise, changing speed or pitch) to improve robustness. At runtime, the server executes only the forward pass to produce an emotion category distribution and a scalar intensity value for each category. The server defines the initial emotional state as the category with maximum probability and its associated score.

The server refines the emotional state using a generative AI model accessed through an API or hosted locally. The server constructs conversation history data by aggregating recent utterance texts and associated simplified acoustic summaries (e.g., “high pitch, fast speech, long silence before response”). The server generates a prompt sentence to instruct the generative AI model to perform contextual emotion estimation. The server, for example, uses the following prompt sentence:

“You are an AI specialized in emotion estimation for conversations in nursing and caregiving. Based on the following conversation history and short descriptions of acoustic features, estimate for each utterance the speaker's emotional state (such as relief, anxiety, anger, sadness, confusion, complaint of pain, loneliness) and a strength score between 0.0 and 1.0. Output a list with timestamp, speaker, emotion label, and emotion score for each utterance.”

The server concatenates the prompt sentence and conversation history into an input text and transmits it to the generative AI model. The generative AI model may be a large-scale transformer model with multiple encoder-decoder or decoder-only layers, trained on large text corpora. The server receives the model's output, parses it into structured emotion labels and scores per utterance, and combines these scores with the initial emotion classification scores. For example, the server may compute a weighted average or apply a rule set in which the generative AI model's score is given higher weight when the conversation window spans more than a predefined number of turns. By integrating model outputs in this way, the server reduces variance and improves consistency of emotion estimation, especially across long dialogues with nuanced context. The system thus improves the technical quality of emotion classification beyond simple heuristics, which in turn improves downstream processing.

The server performs translation of the character string data. The server may call an external neural machine translation engine via an API, or may use an internally hosted encoder-decoder translation model. The server identifies the source and target languages based on the language identifier and configuration associated with the user. The server submits the source text and language pair to the translation engine, obtains translated character string data in the target language, and stores it in memory.

The server adjusts the expression style of the translated text based on the final emotional state and on attribute information of the user. The server includes a rule-based module that maps emotion categories and intensities to style parameters, such as maximum allowed sentence length, vocabulary level, politeness form, and whether to append reassurance phrases. For example, when the care recipient shows high anxiety, the server sets a style parameter “reassurance_required” to true and reduces the permitted sentence length. The server generates a new prompt sentence that instructs the generative AI model to rewrite the text accordingly. In one example, the server uses the following prompt sentence:

“You are a multilingual communication support AI for an elderly care facility. Rewrite the following sentence so that it is easy for an elderly care recipient to understand, avoiding technical terms, using short sentences, and adding expressions that give reassurance. After rewriting in the original language, translate the rewritten sentence into the target language. Output both the rewritten sentence in the original language and the translation in the target language.”

The server appends the current translated text and emotion context to the prompt sentence and submits it to the generative AI model. The server receives an output containing a rewritten source-language sentence and an adjusted translation. The server may further apply its own rule-based checks, such as ensuring certain keywords (e.g., “pain,” “medicine”) are preserved. By combining rules with the generative AI model in a structured manner, the system obtains text that is both context-appropriate and machine-actionable, which is technically different from mere free-form summarization.

The server determines speech synthesis parameters based on the adjusted character string data and the final emotional state. The server uses a mapping table that defines, for each emotion category and intensity range, parameter values for speech rate, pitch, prosody contour, volume, and an identifier of a voice profile. For example, if the care recipient is anxious and elderly, the server selects a voice profile with a calm timbre, reduces speech rate to 0.8 of default, reduces pitch by 1 to 2 semitones, and sets moderate volume. The server may also query the generative AI model with a descriptive prompt sentence, such as:

“You are an AI that designs spoken guidance. The following sentence will be spoken to an elderly person who feels anxious. Briefly describe how the voice should be delivered (speaking speed, pitch, and intensity) so that it sounds gentle and calm.”

The server parses the resulting text (e.g., “speak slightly slowly, in a slightly lower tone, with gentle and steady volume”) into concrete numeric values using predefined mapping rules. The server assembles speech synthesis data including the adjusted text, language code, chosen voice profile, and prosody parameters into a data structure, such as a JSON-like object, and transmits it to the terminal.

The terminal receives the speech synthesis data and uses a text-to-speech (TTS) engine, such as a platform TTS API or a cloud TTS library, to generate audio waveforms. The terminal configures the TTS engine with the speech rate, pitch, volume, and voice profile supplied by the server. The terminal then plays the generated speech through the speaker. The terminal simultaneously displays the adjusted translated text and optionally the original text on the display. In this way, the terminal behaves as an audio-visual output device controlled by speech synthesis parameters determined by the server, so that the system is not limited to abstract data processing but directly controls physical audio output to the user.

The server records conversation record data in a relational database management system such as a general-purpose database server. For each utterance, the server creates a row that contains at least: a session identifier, an utterance identifier, the original character string data, the language identifier, the translated character string data, the adjusted character string data, the final emotional state (category and score), the speech synthesis parameters, time information (start and end timestamps), and speaker information. The server creates indexes on session identifier and time to support efficient retrieval and aggregation. The server thus transforms transient audio and model outputs into a structured, time-aligned data store. This data structure facilitates later computation of statistical patterns and reduces the need for repeated raw audio processing.

The server performs task extraction using the conversation record data and a generative AI model. The server obtains conversation segments over a predetermined time window, such as one care session or one day, and formats them into a textual summary with explicit markers for high-emotion utterances (e.g., by adding tags such as “[HIGH PAIN]”). The server prepares a prompt sentence instructing the generative AI model to output structured task information. For example, the server may use:

“You are a care task extraction AI. From the following conversation history in a nursing care context, extract specific care tasks that should be carried out in the future. For each task, output the task description, the responsible party category (such as care staff, nurse, physician, family), the priority (high, medium, low), and the reason why the task is necessary. Give high priority to tasks related to utterances with high anxiety, pain, or loneliness scores. Output in a structured list.”

The server submits this prompt sentence and the summarized conversation to the generative AI model. The server receives a text output that can be parsed into structured fields. The server uses pattern matching or a lightweight parser to convert the output into internal task records with columns such as task_description, responsible_party_category, priority_level, reason, and status.

The server stores these records in a task table in the database. Because the task extraction is conditioned on emotion-annotated conversation record data, the processor identifies tasks and priorities in a manner not achievable by simple keyword search or manual reading. This structured pipeline improves data management and reduces human cognitive load, while relying on concrete data structures and rules that are implemented in software modules.

The server calculates schedule proposals based on historical conversation record data and care schedule information. The server retrieves, for each care recipient, past session timestamps, average emotional scores per session, and associated caregiver identifiers. The server computes, using statistical routines, an emotional stability degree by day of week and by time zone. For example, the server may compute a variance of emotional scores in each time slot and treat low variance as high stability. The server also calculates an emotional change tendency for each caregiver combination by measuring average score changes before and after sessions with that caregiver. These computations are performed using numerical libraries (e.g., matrix operations on CPU or GPU) and result in numeric indices stored in memory.

The server acquires future caregiver shift schedules and facility operation constraints from a schedule database or another information system. The server creates text data describing these statistics and constraints, and generates a prompt sentence that instructs the generative AI model to propose candidate care session times. For example, the server uses:

“You are an AI for optimizing care schedules. Using the following data about the past sessions and the future staff shifts, determine which days of the week and time periods are relatively stable for the emotions of care recipient A, and which care staff members appear to be a good match. Then propose three candidate care session schedules during the next two weeks, each consisting of a date/time and an assigned staff member, and briefly explain why each candidate is suitable.”

The server submits the descriptive text and prompt sentence to the generative AI model. The server receives one or more schedule proposals that list candidate dates, times, caregivers, and rationale. The server parses this output and checks each candidate against schedule constraint information, such as whether the caregiver is actually on shift and whether there is no conflict with facility rules. The server discards infeasible candidates and registers the remaining feasible candidates as schedule records in the database. The server then transmits the schedule candidates to the terminal.

The terminal displays the task list and schedule candidates in an interactive user interface. The terminal enables the user to confirm, modify, or mark items as completed via touch input or other input modalities. When the user updates the status, the terminal sends the update to the server, and the server writes changes into the database. In this manner, the server and terminal maintain a consistent view of tasks and schedules.

The system achieves technical effects that go beyond mere automation of human business processes. By integrating acoustic feature extraction, neural emotion classification, context-aware refinement by a generative AI model via explicit prompt sentences, and rule-based control of expression style and speech synthesis parameters, the server improves the quality and stability of emotion-aware translation compared with prior systems that rely only on raw sentiment scores. The structured conversation record data with synchronized emotional states enables efficient computation of statistical tendencies and allows the server to automatically derive prioritized tasks and schedule candidates with reduced noise and fewer false positives. The use of chunk-based audio transmission and early processing on the server reduces latency and communication overhead. The division of labor, wherein the server performs heavy inference and the terminal performs real-time TTS and display, optimizes computational load distribution and improves overall system throughput.

Moreover, the system employs particular data structures, prompt sentence designs, and module interactions that cause the generative AI model to emit structured, machine-consumable outputs, rather than arbitrary free text. This architecture enables deterministic post-processing and database registration, which is a concrete improvement in the way the computer processes and manages multimodal conversation data. The emotion-conditioned style adjustment and prosody control reduce misinterpretation and cognitive burden on vulnerable users (such as elderly care recipients), and the server's schedule calculation based on emotional stability indices and compatibility indices yields more appropriate timing for care sessions, thereby reducing the need for manual trial and error.

The server may adopt various alternative embodiments. For example, the emotion classification network may be a recurrent neural network, such as a bidirectional long short-term memory network, instead of a multilayer perceptron. The generative AI model may be hosted on the same server hardware or accessed via an external cloud service. The speech recognition model may be replaced with another multilingual model with a different architecture. The translation module may use a different neural machine translation engine. The statistical computation of emotional tendencies may use, instead of variance, other robustness metrics such as median absolute deviation or quantile-based thresholds. The rule-based mapping from emotion to speech parameters may be replaced or supplemented by a regression model trained on human-rated samples of “comforting” speech. In each case, the server continues to perform a sequence of concrete data transformations and computations, using defined data structures and prompt sentences, to achieve the technical effects of improved emotion-aware translation, task extraction, and schedule proposal.

The user interacts with the system simply by speaking in a natural language and, optionally, performing simple operations on the terminal. The terminal and server cooperate to transform the user's voice into structured information, control audio synthesis devices, and manage technical resources efficiently. Through these detailed arrangements, the present invention provides an implementation form that allows another person skilled in the art to realize the invention and understand how the coordinated use of a generative AI model and prompt sentences improves the operation of computer systems in the context of multilingual, emotion-aware communication and workflow support.

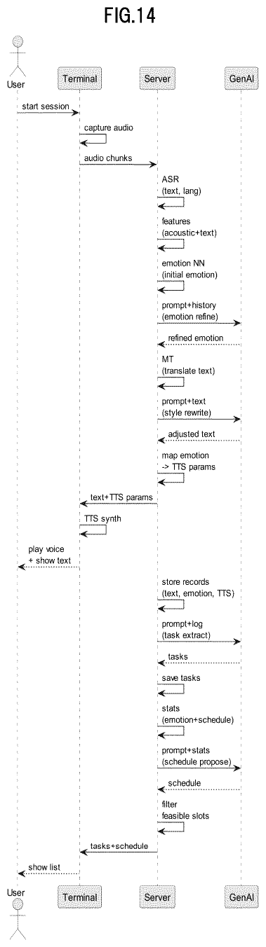

The following describes the processing flow using FIG. 14.

### Step 1:

The user initiates a session on the terminal.

The terminal receives, as input, a user operation such as tapping a “Start” button on a graphical user interface. The terminal, based on this input, allocates buffer memory and initializes an audio capture object provided by the mobile operating system (for example, an audio recording API) with parameters including sampling frequency, bit depth, and channel count. The terminal outputs an internal session identifier and an initialized audio capture state, which are used as inputs to subsequent steps.

### Step 2:

The terminal captures speech audio and constructs audio chunks.

The terminal receives, as input, an analog voice signal from the microphone. The terminal calls the audio API to convert the analog signal into digital audio data (for example, 16-bit PCM at 16 kHz) and stores samples into a ring buffer. The terminal segments the samples into fixed-length chunks (for example, 1 second of audio per chunk), appends a timestamp from the system clock, and attaches speaker metadata (e.g., “caregiver” or “care recipient”) to each chunk. The terminal outputs a sequence of audio-chunk objects, each including raw audio bytes, a timestamp, a session ID, and a speaker label.

### Step 3:

The terminal transmits audio chunks to the server.

The terminal receives, as input, the audio-chunk objects generated in Step 2. The terminal serializes each chunk into a message payload (for example, a JSON or binary frame containing session_id, speaker_type, timestamp, and encoded audio data), encrypts the payload using a transport security protocol, and sends the message via HTTPS or WebSocket through the communication interface. The terminal performs retransmission when necessary according to a retry policy. The terminal outputs network packets addressed to the server, which contain structured audio data and metadata.

### Step 4:

The server receives audio data and prepares it for recognition.

The server receives, as input, the network packets sent from the terminal. The server decodes and decrypts the packets, verifies the session ID, and extracts the raw audio bytes and associated metadata. The server normalizes the amplitude of the audio and, if required, resamples the audio to a predetermined rate used by the speech recognition model. The server outputs normalized audio segments grouped by session and speaker, which are stored in a session-specific buffer for further processing.

### Step 5:

The server computes acoustic features for speech recognition.

The server receives, as input, normalized audio segments from Step 4. The server applies a windowing function (for example, 25 ms windows with 10 ms stride) and uses a digital signal processing library to compute a short-time Fourier transform. The server converts the spectra into log-mel filter bank features to produce a two-dimensional feature matrix (frequency bins×time frames). The server reshapes the matrix into a tensor format required by the speech recognition model and transfers the tensor to the GPU memory. The server outputs feature tensors representing the time-frequency content of the speech.

### Step 6:

The server performs automatic speech recognition.

The server receives, as input, the feature tensors from Step 5. The server executes a multilingual speech recognition model implemented as a neural network (for example, an encoder-decoder transformer) on the GPU. The server computes, for each time step, attention-based hidden states and predicts a sequence of token probabilities, then decodes the most probable token sequence via beam search or greedy decoding. The server converts the token sequence into character string data and obtains a language identifier output by the model. The server associates the recognized text with timestamps and speaker information and outputs utterance objects that include at least text, language code, start time, end time, session ID, and speaker type.

### Step 7:

The server extracts multimodal feature values for emotion estimation.

The server receives, as input, the utterance objects and corresponding raw audio segments. The server uses an audio analysis library to calculate acoustic features for each utterance, such as mean pitch, pitch variance, average short-time energy, speaking rate (derived from voiced segment duration and word count), and silence duration. The server uses a pretrained language model to convert the character string data into contextual text embeddings by passing tokenized text through multiple self-attention layers and pooling the resulting hidden states. The server concatenates or otherwise combines the acoustic feature vector and the text embedding vector into a unified feature vector for each utterance. The server outputs unified feature vectors tagged with utterance identifiers.

### Step 8:

The server executes an emotion classification neural network.

The server receives, as input, the unified feature vectors from Step 7. The server performs a forward pass through an emotion classification model composed, for example, of fully connected layers with nonlinear activation functions and an output layer with softmax activation. The server computes a probability distribution over predefined emotion categories (such as relief, anxiety, sadness, confusion, complaint of pain, loneliness) and an intensity score for each category. The server selects an initial emotional state for each utterance based on the highest probability and the corresponding score. The server outputs initial emotional state data, each associated with an utterance ID.

### Step 9:

The server refines emotional states using a generative AI model.

The server receives, as input, recent utterance texts, acoustic summaries, and initial emotional state data. The server constructs conversation history data by ordering utterances by time and attaching brief descriptions of acoustic features. The server generates a prompt sentence instructing a generative AI model to estimate emotions contextually. The server, for example, prepares the following prompt sentence:
“You are an AI specialized in emotion estimation for conversations in nursing and caregiving. Based on the following conversation history and short descriptions of acoustic features, estimate for each utterance the speaker's emotional state (such as relief, anxiety, anger, sadness, confusion, complaint of pain, loneliness) and a strength score between 0.0 and 1.0. Output a list with timestamp, speaker, emotion label, and emotion score for each utterance.”

The server concatenates the prompt sentence and the conversation history into an input text and sends it to the generative AI model through an API call. The server receives a generated output containing emotion labels and scores per utterance. The server parses this output into structured data and combines it with the initial emotional state data using predefined integration rules (such as weighted averaging or conflict resolution rules). The server outputs final emotional state data for each utterance.

### Step 10:

The server performs language translation of utterances.

The server receives, as input, the utterance objects from Step 6 and configuration data specifying a target language for each listener. The server submits the source text and language pair to a translation engine, which may be an internal neural network or an external API. The server obtains translated character string data in the target language and associates it with the corresponding utterance, timestamps, and speaker information. The server outputs translation objects, each containing at least original text, translated text, source language, target language, and utterance ID.

### Step 11:

The server determines an expression style strategy based on emotional state and user attributes.

The server receives, as input, the translation objects from Step 10, the final emotional state data from Step 9, and user attribute information such as role, age group, and language proficiency.

The server applies rule-based logic to map emotion categories and user attributes to style parameters, such as maximum sentence length, vocabulary level, politeness form, and whether to add reassuring phrases. The server determines whether style adjustment should be performed by a generative AI model, by rule-based rewriting, or by a combination of both. The server outputs style control parameters and a decision indicating the adjustment method for each translation object.

### Step 12:

The server executes emotion-aware text rewriting using a generative AI model.

The server receives, as input, translation objects and style control parameters that require generative rewriting. The server constructs, for each text, a prompt sentence describing the rewriting requirements. The server, for example, uses the following prompt sentence:

“You are a multilingual communication support AI for an elderly care facility. Rewrite the following sentence so that it is easy for an elderly care recipient to understand, avoiding technical terms, using short sentences, and adding expressions that give reassurance. After rewriting in the original language, translate the rewritten sentence into the target language. Output both the rewritten sentence in the original language and the translation in the target language.”

The server appends the original or translated text and, optionally, emotion context (e.g., “listener is highly anxious”) to the prompt sentence and sends the combined text to the generative AI model. The server receives an output containing a rewritten source-language sentence and an adjusted target-language sentence. The server parses the output by splitting it into the two languages and, if needed, performs consistency checks (such as confirming presence of key medical terms). The server outputs adjusted character string data for both source and target languages.

### Step 13:

The server applies rule-based post-processing to adjusted text.

The server receives, as input, the adjusted character string data from Step 12 and the style control parameters from Step 11. The server examines the adjusted text for compliance with style constraints such as maximum sentence length and required keywords. If necessary, the server splits long sentences, replaces high-complexity terms with simpler synonyms, or appends standard reassurance templates selected from a library. The server outputs finalized adjusted target-language text to be used for speech output and display.

### Step 14:

The server generates speech synthesis parameters conditioned on emotional state.

The server receives, as input, the finalized adjusted text from Step 13 and the final emotional state data from Step 9. The server uses a mapping table or a parametric function to convert emotion categories and intensities into speech synthesis parameters, including speech rate, pitch shift, prosody pattern (e.g., degree of intonation variation), volume level, and a speaker profile identifier. Optionally, the server generates a descriptive query to a generative AI model, such as: “You are an AI that designs spoken guidance. The following sentence will be spoken to an elderly person who feels anxious. Briefly describe how the voice should be delivered (speaking speed, pitch, and intensity) so that it sounds gentle and calm.”

The server uses the generative AI response to refine or confirm the parameter selection via rule-based parsing. The server outputs speech synthesis data objects that include the adjusted text, language code, speech rate, pitch, volume, voice profile, and any additional TTS parameters.

### Step 15:

The server transmits speech synthesis data to the terminal.

The server receives, as input, the speech synthesis data objects from Step 14. The server serializes each object into a message (for example, containing text, language, and prosody settings), wraps it in an application-level protocol frame, and sends it to the terminal via HTTPS or WebSocket. The server may also include identifiers that link the speech output to relevant utterances in the conversation record. The server outputs network packets addressed to the terminal, containing complete information for local speech synthesis.

### Step 16:

The terminal performs speech synthesis and displays text.

The terminal receives, as input, the speech synthesis data sent by the server. The terminal parses the message, extracts the text, language code, and speech synthesis parameters, and configures a text-to-speech engine accordingly. The terminal invokes the TTS engine to convert the text into an audio waveform, using the specified speech rate, pitch, volume, and voice profile. The terminal outputs the synthesized audio through the speaker and simultaneously renders the text on the display for visual confirmation, thus providing the user with multimodal feedback.

### Step 17:

The server records conversation and output parameters as conversation record data.

The server receives, as input, the utterance objects (from Step 6), the translation objects (from Step 10), the adjusted text (from Step 13), the final emotional state data (from Step 9), and the speech synthesis parameters (from Step 14). The server constructs database records that include, for each utterance, at least original text, translated text, adjusted text, emotion category and score, timestamps, speaker information, and speech output parameters. The server writes these records into a relational database with indices on session ID, time, and user ID. The server outputs stored conversation record data that is searchable and ready for downstream analysis.

### Step 18:

The server generates input for task extraction using a generative AI model.

The server receives, as input, conversation record data for a predetermined time range. The server selects utterances and their associated emotional states, and marks utterances with emotional scores above a threshold (e.g., high anxiety or pain) with special tags such as “[HIGH PRIORITY]”. The server concatenates the selected utterances into a coherent text that preserves time order and annotates speakers. The server generates a prompt sentence that instructs a generative AI model to output structured tasks. For example, the server uses:

“You are a care task extraction AI. From the following conversation history in a nursing care context, extract specific care tasks that should be carried out in the future. For each task, output the task description, the responsible party category (such as care staff, nurse, physician, family), the priority (high, medium, low), and the reason why the task is necessary. Give high priority to tasks related to utterances with high anxiety, pain, or loneliness scores. Output in a structured list.”

The server concatenates the prompt sentence and conversation text into one input and sends it to the generative AI model. The server outputs the generated text response from the model.

### Step 19:

The server parses task information and builds a task list.

The server receives, as input, the generated text response from Step 18. The server uses pattern matching or a simple parser to identify task entries, extracting fields such as task description, responsible party category, priority, and reason. The server converts these fields into structured task records and inserts them into a task management table in the database. The server outputs an internal task list data structure associated with the session or user.

### Step 20:

The server analyzes emotional tendencies and compatibility indices for scheduling.

The server receives, as input, conversation record data and care schedule information. The server aggregates emotion scores per user by day of week and time slot (for example, morning, afternoon, evening) and computes statistics such as mean and variance. The server defines an emotional stability index based on low variance and favorable mean values. The server also correlates caregiver identifiers with emotional score changes to compute a compatibility index between each care recipient and each caregiver. The server outputs a set of numeric indices and summaries describing emotional tendencies and compatibility.

### Step 21:

The server generates schedule proposals using a generative AI model.

The server receives, as input, the emotional tendency indices, compatibility indices, and future schedule constraint information (e.g., caregiver shifts, facility rules). The server constructs explanatory text that summarizes the indices and constraints and generates a prompt sentence instructing schedule optimization. The server, for example, uses:

“You are an AI for optimizing care schedules. Using the following data about the past sessions and the future staff shifts, determine which days of the week and time periods are relatively stable for the emotions of care recipient A, and which care staff members appear to be a good match. Then propose three candidate care session schedules during the next two weeks, each consisting of a date/time and an assigned staff member, and briefly explain why each candidate is suitable.”

The server concatenates the prompt sentence and the explanatory text into an input and sends it to the generative AI model. The server receives, as output, proposed care session schedules that include candidate dates, times, caregivers, and explanations.

### Step 22:

The server filters and finalizes feasible schedule candidates.

The server receives, as input, the proposed schedules from Step 21 and the schedule constraint information. The server checks each candidate against constraints such as caregiver availability, existing bookings, and facility capacity rules. The server discards or adjusts candidates that violate any constraint and retains those that satisfy all constraints. The server registers feasible candidates as schedule records in the database and outputs a finalized set of candidate next care execution dates and times with assigned caregivers.

### Step 23:

The terminal presents tasks and schedule candidates to the user.

The terminal receives, as input, the task list from Step 19 and the finalized schedule candidates from Step 22. The terminal formats these data for display, for example, by listing tasks with icons indicating priority and by showing schedule options in a calendar or list view. The terminal renders the information on the display and enables interactive operations such as selecting a schedule or marking a task as completed. The terminal outputs updated user actions (such as confirmations or status changes) back to the server in subsequent interactions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

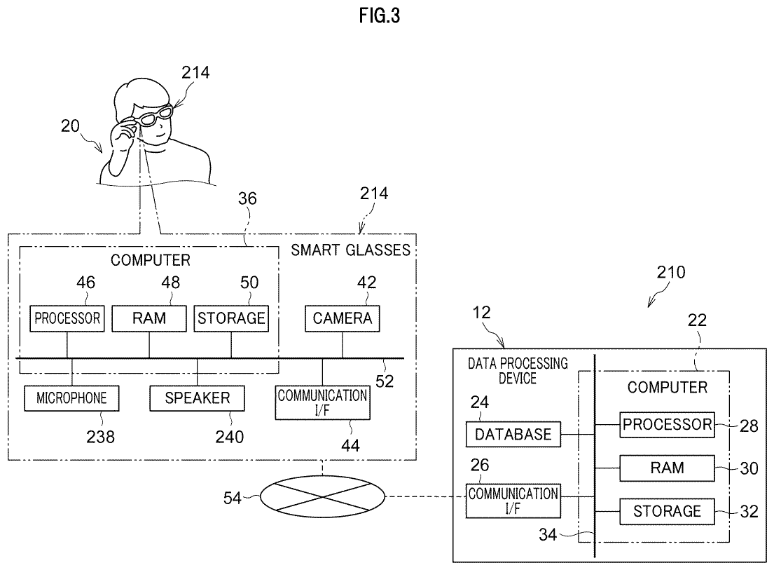

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

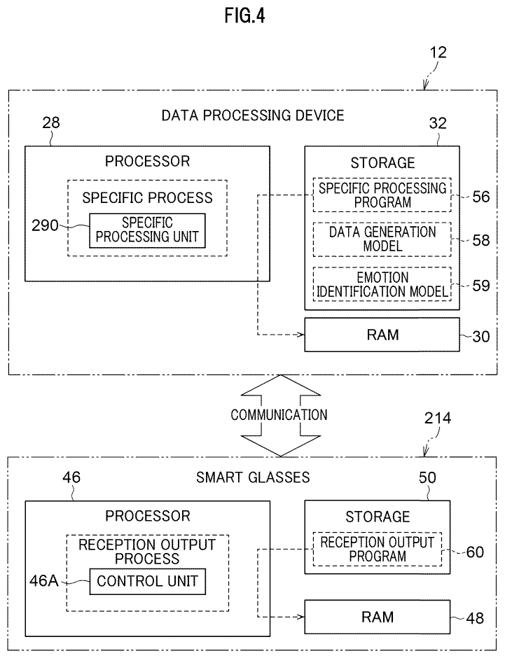

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

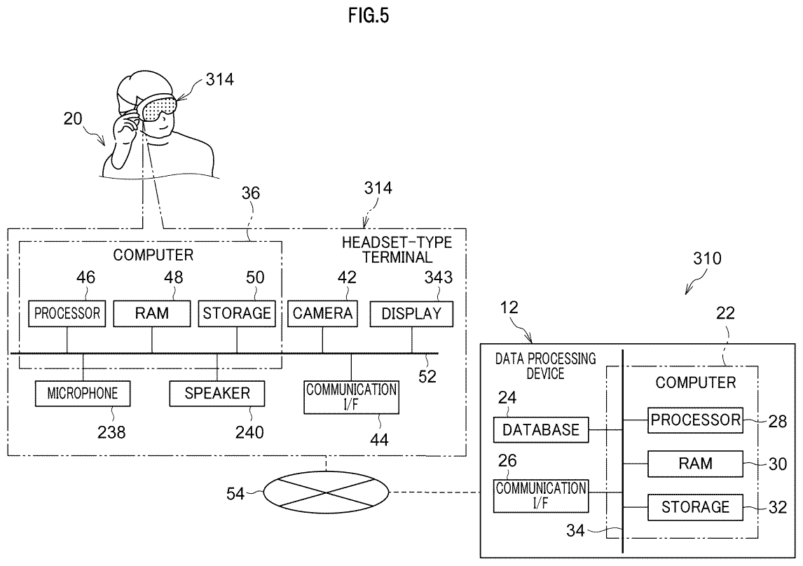

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

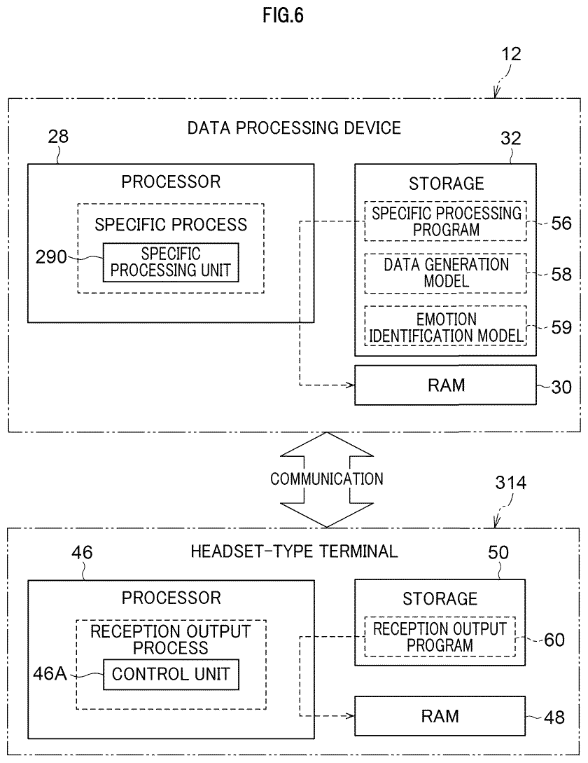

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

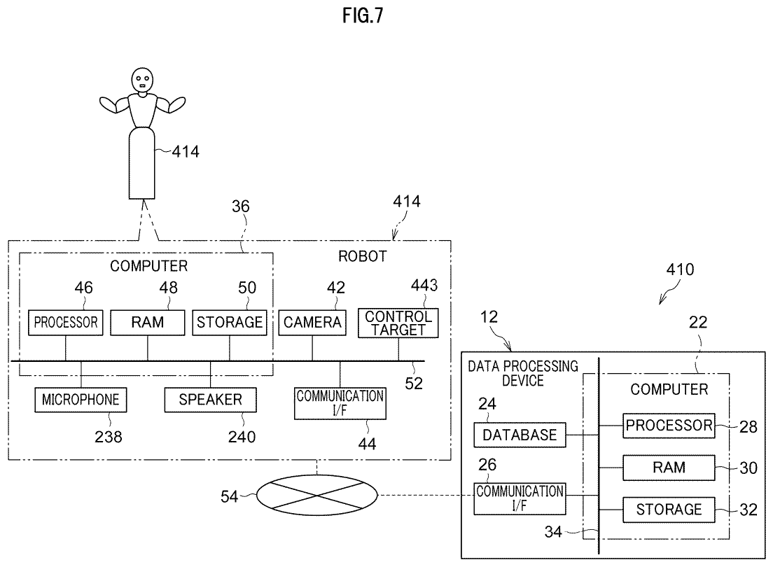

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

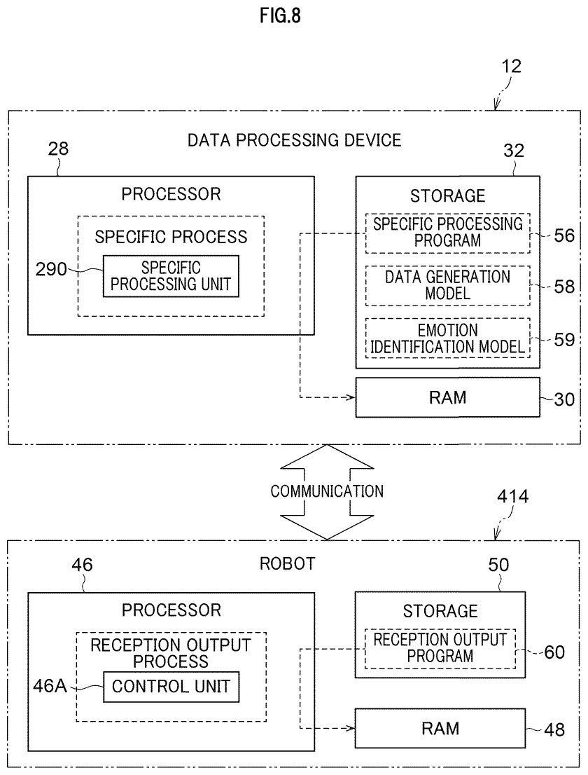

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

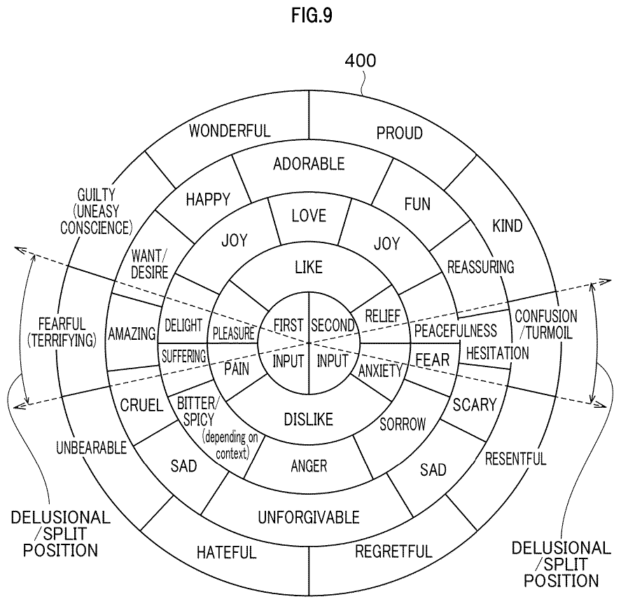

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

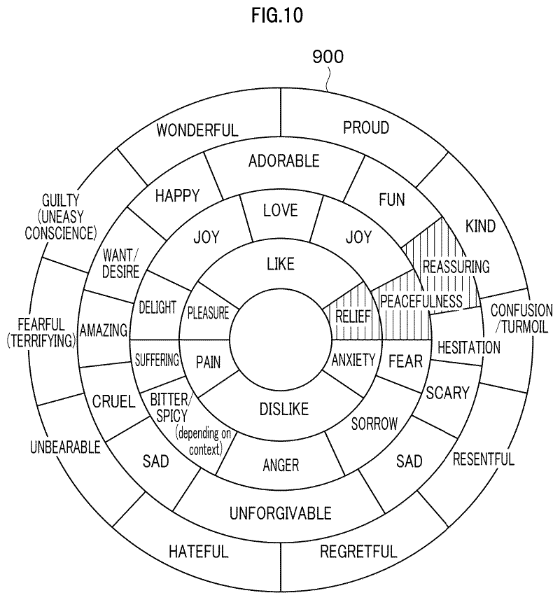

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from an audio input device of each information processing terminal participating in a meeting, an audio signal in a time series, remove noise components from the audio signal while extracting a speech section, automatically determine a language used by a speaker in the speech section, select an acoustic model and a language model corresponding to the determined language, and convert the speech section into character information based on the selected models,
and aggregate, via a communication network, the character information and language-type information corresponding to the character information obtained by the conversion, determine, for each meeting participant, a translation target language of the character information based on display-language information stored in advance for each meeting participant, execute a machine translation process in accordance with the determined translation target language, generate input information including translation character information obtained by the machine translation process and original character information, generate a prompt sentence including a task instruction to translate utterances in the meeting in real time so that participants can immediately understand the utterances, input the input information and the prompt sentence to a generative AI model, and correct a result of the machine translation process using translation character information output from the generative AI model, the translation character information taking into account context, technical terminology, and cultural nuances,
and distribute corrected translation character information obtained by the correction to information processing terminals in accordance with display languages of the respective meeting participants, input the corrected translation character information and a prompt sentence including a task instruction to reproduce translated text as natural audio and convey the translated text to participants to a generative AI model in at least one of the information processing terminals or a server, obtain audio-synthesis parameters or synthesized audio from the generative AI model, convert the corrected translation character information into an audio signal using the audio-synthesis parameters or the synthesized audio, and output the audio signal via an audio output device of the information processing terminal,
and record the character information obtained by the conversion and the corrected translation character information in association with meeting identification information, speaker identification information, and time information, assign search index information to generate meeting record data, store the meeting record data in a storage device, input the meeting record data and a prompt sentence including a task instruction to record all utterances during the meeting and allow the utterances to be easily searched later to a generative AI model, and generate and provide a meeting record organized by agenda based on summary information and structured information output from the generative AI model,
and extract, from the meeting record data, candidate speech sections including task expressions, input the extracted candidate speech sections and a prompt sentence including a task instruction to automatically list tasks decided during the meeting and share the tasks with participants to a generative AI model, automatically generate work-item information including task content, a responsible person, a deadline, and a priority, register the work-item information as task management data in the storage device, and present the task management data to terminals of the respective meeting participants and accept update operations,
and obtain free-time information and time-constraint information of a plurality of participants via schedule-management-information acquisition processing for each meeting participant, generate a set of candidate meeting dates and times based on the free-time information and the time-constraint information, input the set of candidate meeting dates and times and a prompt sentence including a task instruction to propose an optimal meeting date and time in consideration of participants' schedules to a generative AI model, determine a recommended meeting date and time for a subsequent meeting in consideration of a number of possible attendees and time constraints of the respective participants, and register schedule information corresponding to the recommended meeting date and time in schedule-management information of each participant in cooperation with a calendar management function.

### (Supplementary 2)

The system according to supplementary 1,
wherein the processor is configured to
aggregate the meeting record data on a per-meeting basis, input the aggregated meeting record data and a prompt sentence including a task instruction to summarize utterance content in the meeting and organize main discussion points, decisions, and unresolved issues to a generative AI model, generate structured minutes data including speaker information and time information based on output from the generative AI model, store the minutes data in a format storable in a storage device connected to a network, and, in response to a viewing request from a terminal, provide all or part of the minutes data.

### (Supplementary 3)

The system according to supplementary 1,
wherein the processor is configured to
input the meeting record data, the work-item information, and a prompt sentence including a task instruction to propose an optimal meeting date and time in consideration of participants' schedules and a task instruction to grasp task status for follow-up after the meeting and perform reminders as needed to a generative AI model, and, based on recommended meeting date-and-time information and task-importance evaluation information output from the generative AI model, perform presentation of candidate meeting dates and times, automatic registration of schedule information, and generation of notification information according to task progress.

### Application Example 1

### (Supplementary 1)

A system comprising a processor,
wherein the processor is configured to
acquire and pre-process audio information from one or more input devices,
convert the acquired audio information into character information and identify a language used by a speaker,
determine a translation target language on the basis of the identified language and a dialogue situation, generate a prompt sentence including a translation policy and a terminology-handling policy, input the prompt sentence and the character information into a generative information processing model, and obtain translated character information from the generative information processing model,
convert the obtained translated character information into audio information, control an audio profile and a speech characteristic in accordance with predetermined speaker attributes and listener attributes, and output the audio information,
structure and store the acquired character information and the translated character information on the basis of dialogue units and time information, and manage the structured information as a searchable record,
extract action-request information on the basis of the acquired character information and the translated character information, and generate and manage task information including deadline information, priority information, and person-in-charge information corresponding to the action-request information, and
acquire schedule information of a user or a subject person, calculate a next execution time on the basis of the task information and the schedule information, and cooperate with a schedule management information processing device to automatically register or update the schedule information.

### (Supplementary 2)

The system according to supplementary 1,
wherein the processor is configured to
classify the acquired character information and the translated character information for each dialogue interval, input the dialogue interval and a prompt sentence including a summarization policy and items to be emphasized into the generative information processing model, obtain summary information corresponding to the dialogue interval from the generative information processing model, store the summary information in association with the searchable record, and present the summary information and the searchable record in accordance with a search condition.

### (Supplementary 3)

The system according to supplementary 1,
wherein the processor is configured to
input the acquired character information and the translated character information, together with a prompt sentence including a task-extraction condition and an output format, into the generative information processing model, obtain structured task information from the generative information processing model as a response, analyze the structured task information, register the structured task information as the task information, and present and update the task information in association with the schedule information.

### Example 2

### (Supplementary 1)

A system comprising a processor,
wherein the processor is configured to
obtain, from an information processing apparatus used by a meeting participant, an audio signal of a spoken utterance, perform speech recognition processing on the audio signal to convert the audio signal into text information, extract from the audio signal acoustic feature information including at least pitch, energy, spectral characteristics, silence interval information, and speaking rate, and generate meeting utterance information including the text information, the acoustic feature information, speaker information, and language information,
input the acoustic feature information included in the meeting utterance information into a machine learning model to calculate first emotion scores, input the text information and a prompt sentence that specifies emotion estimation content and output format into a generative AI model to calculate second emotion scores, and integrate the first emotion scores and the second emotion scores with predetermined weighting to determine emotion information for each utterance, the emotion information including an emotion label and an emotion intensity,
generate a translation prompt sentence that specifies processing content and output format for generating a translation text which (i) preserves a semantic content of the text information, (ii) is expressed in a polite and calm style appropriate for business communication, and (iii) controls an emotional nuance based on the emotion information, and input the translation prompt sentence and the text information into the generative AI model to generate, as an output of the generative AI model, translation text in a target language and an emotion profile including tone information corresponding to the emotion information,
generate a speech synthesis parameter generation prompt sentence for causing the generative AI model to propose speech synthesis parameters including at least pitch, speaking rate, volume, and pause length of a synthesized speech, input the speech synthesis parameter generation prompt sentence and the translation text into the generative AI model to obtain the speech synthesis parameters, and transmit the speech synthesis parameters and the translation text to the information processing apparatus used by the meeting participant for controlling a speech synthesis engine, and
store, on a recording medium, the meeting utterance information, the emotion information, and the translation text on a per-meeting basis, generate a minutes summarization prompt sentence that specifies viewpoints and output format for summarizing meeting minutes using the stored information, and input the minutes summarization prompt sentence and the stored information into the generative AI model to generate minutes summary data that reflects emotion tendencies in each agenda item and emotion-important discussion points.

### (Supplementary 2)

The system according to supplementary 1,
wherein the processor is configured to
generate a task extraction prompt sentence for, based on the meeting utterance information and the emotion information, extracting work items decided during a meeting and generating task information including at least task content, assignee information, deadline information, and emotion information related to each work item, input the task extraction prompt sentence and the meeting utterance information and the emotion information into the generative AI model to obtain the task information, assign, to each task included in the task information, a management attribute indicating at least a burden degree or an anxiety degree of the assignee based on the emotion information included in the task information, and perform list display or priority control of the tasks in accordance with the management attribute.

### (Supplementary 3)

The system according to supplementary 1,
wherein the processor is configured to
use, after completion of a meeting, the meeting utterance information, the minutes summary data, and the emotion information as input, generate a next-agenda proposal prompt sentence for extracting discussion points with high anxiety or confusion of participants and generating candidate agenda items and reasons therefor for a next meeting, input the next-agenda proposal prompt sentence and the meeting utterance information and the emotion information into the generative AI model to obtain agenda proposals for the next meeting, and generate, based on the agenda proposals and schedule information of the participants obtained from a schedule management system, combinations of candidate date-time slots and agenda items for the next meeting and present the combinations to the participants.

### Application Example 2

### (Supplementary 1)

A system comprising a processor,
wherein the processor is configured to
acquire audio data transmitted from an information processing terminal that captures speech of a user, and convert the speech content of the user into character string data,
extract feature values from the character string data and from the audio data, and estimate an emotional state of the user based on the feature values, generate conversation history data and acoustic feature summary data together with a predetermined prompt sentence, input the conversation history data, the acoustic feature summary data, and the predetermined prompt sentence to a generative AI model, obtain a context-based correction of the emotional state from the generative AI model, integrate a result of the correction with a result of the estimation based on the feature values, and determine a final emotional state,
convert the character string data into other character string data in a language different from a language of the user,
generate, in accordance with the final emotional state and attribute information of the user, a prompt sentence including, as input text, the other character string data obtained by the conversion, input the prompt sentence and the input text to the generative AI model, obtain, from the generative AI model, adjusted character string data in which an expression style including at least one of sentence length, vocabulary difficulty, use of honorific expressions, and presence or absence of reassuring expressions is adjusted, and/or change the expression style by rule-based processing based on the final emotional state,
determine, based on the adjusted character string data and the final emotional state, speech synthesis parameters representing at least one of speech rate, pitch, prosody, volume, and speaker profile, generate speech synthesis data including the adjusted character string data and the speech synthesis parameters, and transmit the speech synthesis data to the information processing terminal,
store, in association on a time series basis, at least the character string data, the other character string data obtained by the conversion, the adjusted character string data, the final emotional state, the speech synthesis parameters, and time information and speaker information corresponding thereto as conversation record data,
input, as text data, at least a part of the conversation record data and a prompt sentence to the generative AI model, obtain task information including at least a content of a future work item to be executed, a responsible party category, a priority, and a reason why the work item is required, and generate a task list based on the task information,
analyze emotional states stored in the conversation record data and care schedule information, calculate at least an emotional tendency by time slot and a compatibility index between the user and a caregiver, generate text data describing analysis results and future schedule constraint information together with a prompt sentence, input the text data and the prompt sentence to the generative AI model, obtain from the generative AI model a plurality of schedule proposals including candidate next care execution dates and times and candidate caregivers, compare the plurality of schedule proposals with the schedule constraint information, and calculate feasible candidates for next care execution dates and times, and
cause the information processing terminal to execute speech synthesis processing based on the speech synthesis data, and to present the task list and the feasible candidates for next care execution dates and times in a displayable and operable format.

### (Supplementary 2)

The system according to supplementary 1,
wherein the processor is configured to
acquire, from the conversation record data, conversation history data and emotional state data for a predetermined period, generate text data in which utterances whose emotional intensity exceeds a predetermined threshold are emphasized, generate a prompt sentence that specifies that work items related to utterances with high emotional intensity are to be assigned a high priority, input the text data and the prompt sentence to the generative AI model, obtain, from the generative AI model, a plurality of work items prioritized based on the emotional state, and register, in the task list as management data, for each of the plurality of work items, at least a task description, the responsible party category, the priority, and the reason.

### (Supplementary 3)

The system according to supplementary 1,
wherein the processor is configured to
perform statistical processing on past care session execution dates and times stored in the conversation record data, an average emotional score in each session, and caregiver information, calculate, for each care recipient, at least an emotional stability degree by day of week and by time zone and an emotional change tendency for each caregiver combination, generate text data describing results of the calculation, future caregiver shift schedules, and facility operation conditions together with a prompt sentence that specifies that days of week and time zones in which emotions of the care recipient tend to be relatively stable and caregivers that are compatible with the care recipient are to be estimated and that a plurality of candidate care execution dates and times and candidate caregivers within a predetermined period are to be proposed, input the text data and the prompt sentence to the generative AI model, obtain, from the generative AI model, a plurality of candidate care execution dates and times and candidate caregivers, and select, as the feasible candidates for next care execution dates and times, ones of the plurality of candidate care execution dates and times and candidate caregivers that satisfy the caregiver shift schedules and the facility operation conditions.

What is claimed is:

1. A system comprising:
circuitry configured to:
receive, via a communication interface coupled to a packet-switched network, audio data from a plurality of terminal devices in a communication session;
perform speech recognition on the audio data to generate text data for each terminal device;
translate the text data into one or more target languages associated with respective terminal devices;
convert the translated text data into synthesized audio data; and
transmit the synthesized audio data to the respective terminal devices via the communication interface.

2. The system according to claim 1, wherein the circuitry automatically determines a source language for each audio stream, selects an acoustic model and a language model corresponding to the determined language, and performs the speech recognition using the selected models.

3. The system according to claim 2, wherein the circuitry performs noise reduction and speech section extraction on the audio data prior to the speech recognition, and determines the source language based on acoustic characteristics of each speech section.

4. The system according to claim 3, wherein the circuitry associates participant identifier information with display language preference information stored in a storage device, and determines the one or more target languages for each terminal device based on the display language preference information.

5. The system according to claim 4, wherein the circuitry constructs a prompt data structure encoding the translated text data and original text data, transmits the prompt data structure to a generative neural network model comprising a transformer-based architecture, and receives refined translation text data that preserves context, technical terminology, and cultural nuances.

6. The system according to claim 1, wherein the circuitry converts the translated text data into the synthesized audio data using a speech synthesis model with prosodic characteristics matched to a source speaker.

7. The system according to claim 6, wherein the circuitry stores the text data and the translated text data as time-series transcript data in a storage device organized by speaker identifier and timestamp, and transmits the transcript data to the plurality of terminal devices for display in each respective target language.

8. The system according to claim 7, wherein the circuitry generates summary data from the transcript data by constructing a summary prompt data structure encoding the transcript data and a summarization task specification, transmitting the summary prompt data structure to a generative neural network model, and receiving structured summary data including key discussion points and decision items.

9. The system according to claim 8, wherein the circuitry automatically extracts action items from the structured summary data, generates task assignment data associating each action item with a participant identifier and a deadline, and transmits the task assignment data to the respective terminal devices.

10. The system according to claim 1, wherein the circuitry performs speaker diarization on the audio data to distinguish utterances from different participants, and associates each text segment with a speaker identifier for attribution in transcript data.

11. The system according to claim 10, wherein the circuitry detects overlapping speech segments in the audio data, processes each overlapping segment independently using separate speech recognition instances, and resolves temporal ordering of the resulting text data based on timestamp information.

12. The system according to claim 11, wherein the circuitry calculates speech activity statistics for each participant including speaking duration, interruption frequency, and response latency, and includes the speech activity statistics in summary data.

13. The system according to claim 1, wherein the circuitry is further configured to detect terminology inconsistencies in the translated text data by comparing against a terminology dictionary stored in a storage device, and to correct the translated text data to maintain consistent terminology usage across the communication session.

14. The system according to claim 13, wherein the circuitry updates the terminology dictionary based on new terms identified during the communication session and approved by a participant via the terminal device.

15. The system according to claim 1, wherein the circuitry is further configured to propose scheduling data for a subsequent communication session by analyzing calendar availability data received from the plurality of terminal devices, and to transmit the scheduling data to the terminal devices for confirmation.

16. The system according to claim 15, wherein the circuitry generates pre-session briefing data by constructing a briefing prompt data structure encoding summary data from a previous communication session and outstanding action items, transmitting the briefing prompt data structure to a generative neural network model, and distributing received briefing text to the terminal devices.

17. The system according to claim 1, wherein the circuitry estimates an engagement level of each participant based on speech activity frequency and response timing patterns extracted from the audio data, and detects sentiment indicators in the text data using a natural language processing model.

18. A system comprising:
circuitry configured to:
receive, via a communication interface coupled to a packet-switched network, audio data from a plurality of terminal devices in a communication session and automatically determine a source language for each audio stream;
perform speech recognition on the audio data using acoustic models and language models corresponding to the determined source languages to generate text data;
translate the text data into target languages using a machine translation model and refine the translated text data by transmitting a prompt data structure to a generative neural network model comprising a transformer architecture with a plurality of self-attention layers;
convert the refined text data into synthesized audio data using a speech synthesis model with prosodic characteristics matched to source speakers;
store the text data and the translated text data as transcript data in a storage device and generate summary data and action item data from the transcript data using the generative neural network model; and
transmit the synthesized audio data, transcript data, and summary data to the respective terminal devices via the communication interface.

19. The system according to claim 18, wherein the circuitry is further configured to perform speaker diarization, detect overlapping speech, and calculate speech activity statistics for each participant.

20. A method performed by circuitry of a server coupled to a packet-switched network via a communication interface, the method comprising:
receiving, via the communication interface, audio data from a plurality of terminal devices in a communication session;
performing speech recognition on the audio data to generate text data for each terminal device;
translating the text data into one or more target languages associated with respective terminal devices;
converting the translated text data into synthesized audio data; and
transmitting the synthesized audio data to the respective terminal devices via the communication interface.
